(19) United States
(12) Patent Application Publication
(10) Pub. No.: US 2017/0133134 A1
(43) Pub. Date: May 11, 2017

(54) METHOD AND APPARATUS FOR WIRELESS POWER TRANSMISSION UTILIZING SELF-STABILIZED ARRAYS OF MAGNETO-MECHANICAL OSCILLATORS

(71) Applicant: QUALCOMM Incorporated, San Diego, CA (US)

(72) Inventors: Johan Pohl, Freiburg (DE); Sebastian Marc Wuestner, Ennetbaden (CH)

(21) Appl. No.: 15/069,821

(22) Filed: Mar. 14, 2016

Related U.S. Application Data
(60) Provisional application No. 62/252,927, filed on Nov. 9, 2015.

(51) Int. Cl. H01F 7/02; H01F 7/14

(52) U.S. Cl. CPC H01F 7/0242; H01F 7/14

(57) ABSTRACT

An apparatus for transferring power wirelessly is provided. The apparatus comprises a plurality of magneto-mechanical oscillators. Each magneto-mechanical oscillator comprises a magnetic element disposed at a vertex of a rhombic lattice. Each magneto-mechanical oscillator is configured to generate a second time-varying magnetic field via movement of the magnetic element of each of the plurality of magneto-mechanical oscillators caused by a first time-varying magnetic field.

### CLAIM OF PRIORITY UNDER 35 U.S.C. §119

The present Application for Patent claims priority to Provisional Application No. 62/252,927 entitled “METHOD AND APPARATUS FOR WIRELESS POWER TRANSMISSION UTILIZING SELF-STABILIZED ARRAYS OF MAGNETO-MECHANICAL OSCILLATORS” filed Nov. 9, 2015, and assigned to the assignee hereof. Provisional Application No. 62/252,927 is hereby expressly incorporated by reference herein.

### FIELD

The present disclosure relates generally to wireless power transmission, and more specifically, to methods and apparatuses for wireless power transmission utilizing self-stabilized arrays of magneto-mechanical oscillators.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections through cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices or provide power to electronic devices may overcome some of the deficiencies of wired charging solutions. As such, methods and apparatuses for wireless power transmission utilizing self-stabilized arrays of magneto-mechanical oscillators are desirable.

### SUMMARY

Some implementations provide an apparatus for transferring power wirelessly. The apparatus comprises a plurality of magneto-mechanical oscillators. Each magneto-mechanical oscillator comprises a magnetic element disposed at a vertex of a rhombic lattice. Each magneto-mechanical oscillator is configured to generate a second time-varying magnetic field via movement of the magnetic element of each of the plurality of magneto-mechanical oscillators caused by a first time-varying magnetic field.

Some other implementations provide a method of transferring power wirelessly. The method comprises generating a second time-varying magnetic field via movement of a magnetic element of each of a plurality of magneto-mechanical oscillators caused by a first time-varying magnetic field, the magnetic element of each of the plurality of magneto-mechanical oscillators disposed at a vertex of a rhombic lattice.

Some other implementations provide a method for fabricating an apparatus for wireless power transmission. The method comprises fabricating each of a plurality of magneto-mechanical oscillators disposed at a vertex of a rhombic lattice by providing a substrate, forming a holder over the substrate, and depositing a magnetic layer on the holder at the vertex of the rhombic lattice.

Some other implementations provide an apparatus for transferring power wirelessly. The apparatus comprises means for generating a first time-varying magnetic field. The apparatus comprises a plurality of means for generating a second time-varying magnetic field via movement of the means for generating the second time-varying magnetic field caused by the first time-varying magnetic field. Each means for generating the second time-varying magnetic field is disposed at a vertex of a rhombic lattice.

### BRIEF DESCRIPTION OF THE DRAWINGS

FIG. 1 is a functional block diagram of a wireless power transfer system, in accordance with some implementations.

FIG. 2 is a functional block diagram of components that may be used in the wireless power transfer system of FIG. 1, in accordance with some implementations.

FIG. 3 is a schematic diagram of a portion of transmit circuitry or receive circuitry of FIG. 2 including a transmit or receive coupler.

FIG. 4 is a functional block diagram of a transmitter that may be used in the wireless power transfer system of FIG. 1, in accordance with some implementations.

FIG. 5 is a functional block diagram of a receiver that may be used in the wireless power transfer system of FIG. 1, in accordance with some implementations.

FIG. 6 illustrates non-radiative inductive power transfer based on Faraday's law using capacitively loaded wire loops at both the transmit and receive sides.

FIG. 7 schematically illustrates an example magneto-mechanical oscillator, in accordance with some implementations.

FIG. 8 schematically illustrates an example magneto-mechanical oscillator (e.g., a portion of a plurality of magneto-mechanical oscillators) with a coupling coil wound around (e.g., surrounding) the magneto-mechanical oscillator, in accordance with some implementations.

FIG. 9 schematically illustrates an example power transmitter configured to wirelessly transfer power to at least one power receiver, in accordance with some implementations.

FIG. 10 schematically illustrates an example power transmitter, in accordance with some implementations, and a plot of input impedance versus frequency showing a resonance phenomenon.

FIG. 11 schematically illustrates a portion of a configuration of a plurality of magneto-mechanical oscillators, in accordance with some implementations.

FIG. 12 schematically illustrates a configuration of the plurality of magneto-mechanical oscillators in which magnetic elements are pairwise oriented in opposite directions so that the static component of the sum magnetic moment cancels out, in accordance with some implementations.

FIG. 13 illustrates a magneto-mechanical oscillator, in accordance with some implementations.

FIG. 14 illustrates a 2-dimensional nested array of the magneto-mechanical oscillators of FIG. 13, in accordance with some implementations.

FIG. 15 illustrates a 2-dimensional nested array of the magneto-mechanical oscillators of FIG. 13, in accordance with some implementations.

FIG. 16 illustrates a 2-dimensional nested array of the magneto-mechanical oscillators of FIG. 13, in accordance with some implementations.

FIG. 17 illustrates a 2-dimensional nested array of the magneto-mechanical oscillators of FIG. 13, in accordance with some implementations.

FIG. 18 illustrates a 3-dimensional nested array of the magneto-mechanical oscillators of FIG. 13, in accordance with some implementations.

FIG. 19 schematically illustrates an example configuration of a power transmitter and a power receiver, in accordance with some implementations.

FIG. 20 is a flowchart of a method for transmitting power wirelessly, in accordance with some implementations.

FIG. 21 is a flowchart of a method for fabricating a plurality of magneto-mechanical oscillators, in accordance with some implementations.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of implementations of the invention and is not intended to represent the only implementations in which the invention may be practiced. The term “exemplary” used throughout this description means “serving as an example, instance, or illustration,” and should not necessarily be construed as preferred or advantageous over other implementations. The detailed description includes specific details for the purpose of providing a thorough understanding of the implementations of the invention. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a receiver to achieve power transfer.

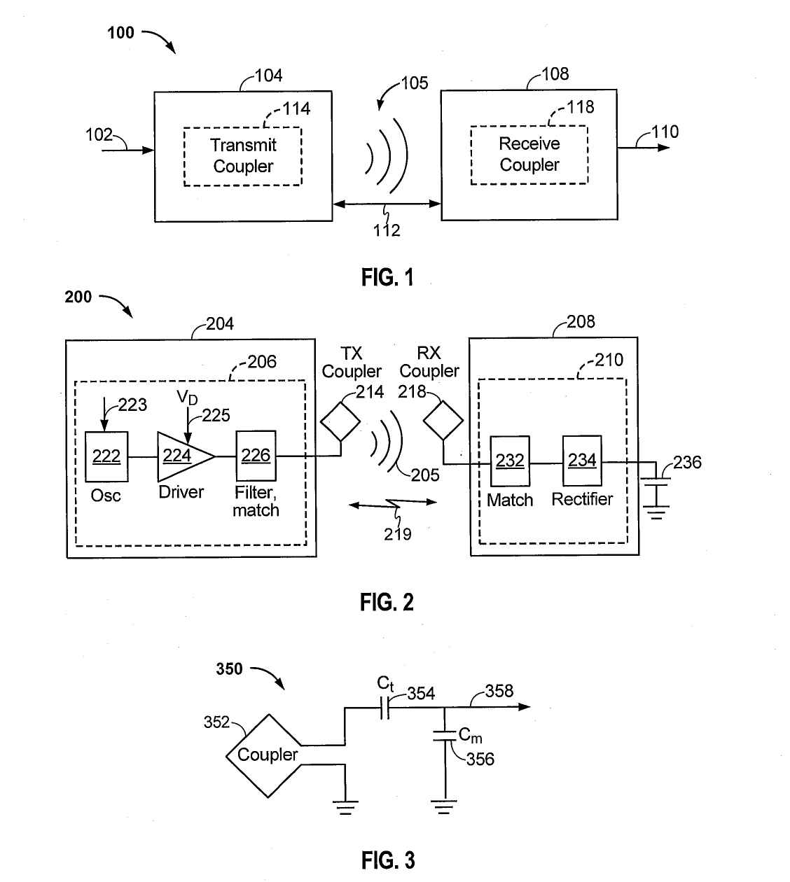

FIG. 1 is a functional block diagram of a wireless power transfer system 100, in accordance with some implementations. Input power 102 may be provided to a transmitter 104 from a power source (not shown) to generate a wireless (e.g., magnetic or electromagnetic) field 105 via a transmit coupler 114 for performing energy transfer. The receiver 108 may receive power when the receiver 108 is located in the wireless field 105 produced by the transmitter 104. The wireless field 105 corresponds to a region where energy output by the transmitter 104 may be captured by the receiver 108. A receiver 108 may couple to the wireless field 105 and generate output power 110 for storing or consumption by a device (not shown in this figure) coupled to the output power 110. Both the transmitter 104 and the receiver 108 are separated by a distance 112.

In one example implementation, power is transferred inductively via a time-varying magnetic field generated by the transmit coupler 114. The transmitter 104 and the receiver 108 may further be configured according to a mutual resonant relationship. When the resonant frequency of the receiver 108 and the resonant frequency of the transmitter 104 are substantially the same or very close, transmission losses between the transmitter 104 and the receiver 108 are minimal. However, even when resonance between the transmitter 104 and receiver 108 are not matched, energy may be transferred, although the efficiency may be reduced. For example, the efficiency may be less when resonance is not matched. Transfer of energy occurs by coupling energy from the wireless field 105 of the transmit coupler 114 to the receive coupler 118, residing in the vicinity of the wireless field 105, rather than propagating the energy from the transmit coupler 114 into free space.

Resonant coupling techniques may thus allow for improved efficiency and power transfer over various distances and with a variety of magneto-mechanical oscillator coupler configurations.

The receiver 108 may receive power when the receiver 108 is located in the wireless field 105 produced by the transmitter 104. The wireless field 105 corresponds to a region where energy output by the transmitter 104 may be captured by the receiver 108. The wireless field 105 may correspond to the “near-field” of the transmitter 104 as will be further described below. The transmitter 104 may include a transmit coupler 114 for coupling energy to the receiver 108. The receiver 108 may include a receive coupler 118 for receiving or capturing energy transmitted from the transmitter 104. The near-field may correspond to a region in which there are strong reactive fields resulting from the magnetic and/or electromagnetic fields generated by the transmit coupler 114 that minimally radiate power away from the transmit coupler 114. The near-field may correspond to a region that is within about one wavelength (or a fraction thereof) of the fundamental frequency at which the transmit coupler 114 operates.

As described above, efficient energy transfer may occur by coupling a large portion of the energy in the wireless field 105 to the receive coupler 118 rather than propagating most of the energy in an electromagnetic wave to the far field. When positioned within the wireless field 105, a “coupling mode” may be developed between the transmit coupler 114 and the receive coupler 118. The area around the transmit coupler 114 and the receive coupler 118 where this coupling may occur is referred to herein as a coupling-mode region.

FIG. 2 is a functional block diagram of a wireless power transfer system 200, in accordance with some other implementations. The system 200 may be a wireless power transfer system of similar operation and functionality as the system 100 of FIG. 1. However, the system 200 provides additional details regarding the components of the wireless power transfer system 200 as compared to FIG. 1. The system 200 includes a transmitter 204 and a receiver 208. The transmitter 204 includes transmit circuitry 206 that includes an oscillator 222, a driver circuit 224, and a filter and matching circuit 226. The oscillator 222 may be configured to generate a signal at a desired frequency that may be adjusted in response to a frequency control signal 223. The oscillator 222 provides the oscillator signal to the driver circuit 224. The driver circuit 224 may be configured to drive the transmit coupler 214 at a resonant frequency of the transmit coupler 214 based on an input voltage signal (V_{D}) 225.

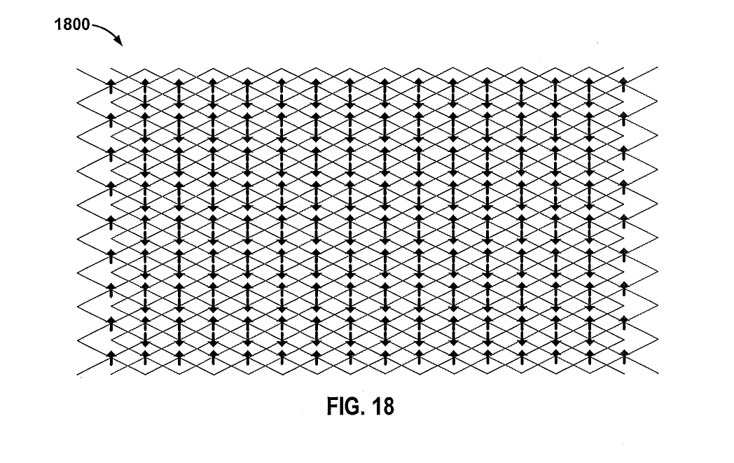

The filter and matching circuit 226 filters out harmonics or other unwanted frequencies and matches the impedance of the transmit circuitry 206 to the transmit coupler 214. As a result of driving the transmit coupler 214, the transmit coupler 214 generates a wireless field 205 to wirelessly output power at a level sufficient for charging a battery 236. As will be described in more detail in connection with FIGS. 18-37 below, the transmit coupler 214 may be configured to excite one or more (e.g., a 2-dimensional or 3-dimensional array of) magneto-mechanical oscillators (not shown in FIG. 2) to physically oscillate about at least one rotation axis in resonance with the wireless field 205. The physical resonant oscillation of the magneto-mechanical oscillators may reinforce the wireless field 205, increasing its strength.

The receiver 208 comprises receive circuitry 210 that includes a matching circuit 232 and a rectifier circuit 234. The matching circuit 232 may match the impedance of the receive circuitry 210 to the impedance of the receive coupler 218. The rectifier circuit 234 may generate a direct current (DC) power output from an alternate current (AC) power input to charge the battery 236. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205. In some implementations, the receiver 208 may be configured to determine whether an amount of power transmitted by the transmitter 204 and received by the receiver 208 is appropriate for charging the battery 236.

FIG. 3 is a schematic diagram of a portion of the transmit circuitry 206 or the receive circuitry 210 of FIG. 2. As illustrated in FIG. 3, transmit or receive circuitry 350 may include a coupler 352. The coupler 352 may also be referred to or be configured as a “conductor loop”, a coil, an inductor, or a “magnetic” coupler. The teen “coupler” generally refers to a component that may wirelessly output or receive energy for coupling to another “coupler.”

The resonant frequency of the loop or magnetic couplers is based on the inductance and capacitance of the loop or magnetic coupler. Inductance may be simply the inductance created by the coupler 352, whereas, capacitance may be added via a capacitor (or the self-capacitance of the coupler 352) to create a resonant structure at a desired resonant frequency. As a non-limiting example, a capacitor 354 and a capacitor 356 may be added to the transmit or receive circuitry 350 to create a resonant circuit that selects a signal 358 at a resonant frequency. For larger sized couplers using large diameter couplers exhibiting larger inductance, the value of capacitance needed to produce resonance may be lower. Furthermore, as the size of the coupler increases, coupling efficiency may increase. This is mainly true if the size of both transmit and receive couplers increase. For transmit couplers, the signal 358, with a frequency that substantially corresponds to the resonant frequency of the coupler 352, may be an input to the coupler 352.

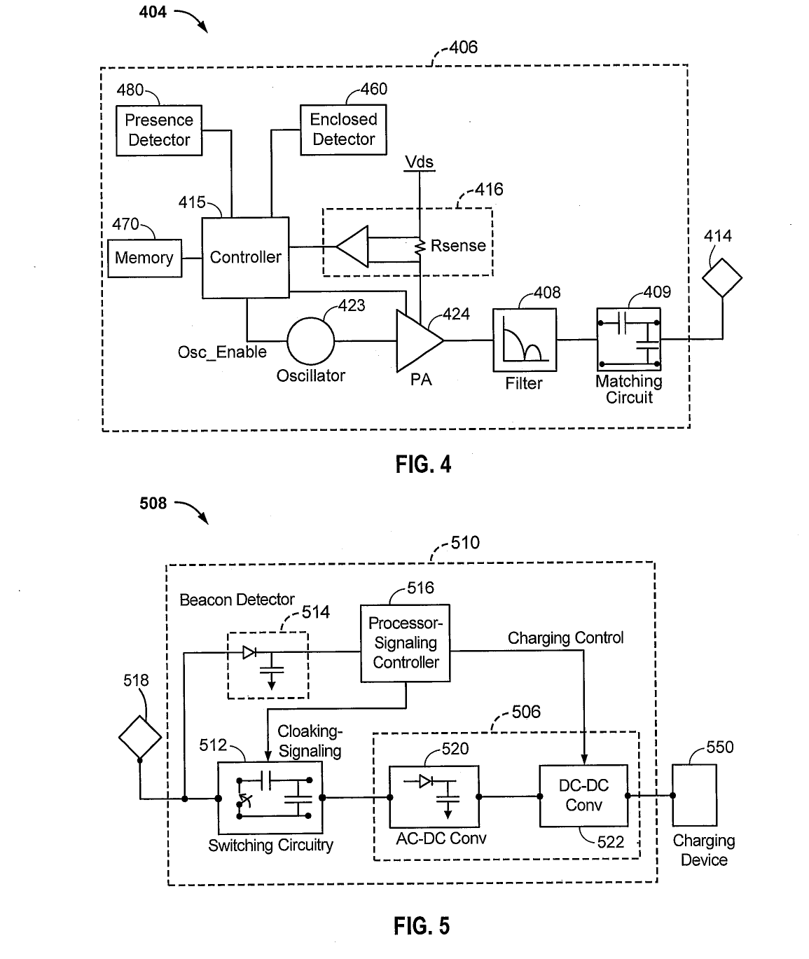

FIG. 4 is a functional block diagram of a transmitter 404 that may be used in the wireless power transfer system of FIG. 1, in accordance with some implementations of the invention. The transmitter 404 may include transmit circuitry 406 and a transmit coupler 414. The transmit coupler 414 may be the coupler 352 as shown in FIG. 3. Transmit circuitry 406 may provide radio frequency (RF) power to the transmit coupler 414 by providing an oscillating signal resulting in generation of energy (e.g., magnetic flux) about the transmit coupler 414. Transmitter 404 may operate at any suitable frequency.

Transmit circuitry 406 may include a fixed impedance matching circuit 409 for matching the impedance of the transmit circuitry 406 (e.g., 50 ohms) to the transmit coupler 414 and a low pass filter (LPF) 408 configured to reduce harmonic emissions to levels to prevent self-jamming of devices coupled to a receiver 108 (FIG. 1). Other implementations may include different filter topologies, including but not limited to, notch filters that attenuate specific frequencies while passing others and may include an adaptive impedance match, that may be varied based on measurable transmit metrics, such as output power to the coupler 414 or DC current drawn by the driver circuit 224. Transmit circuitry 406 further includes a driver circuit 424 configured to drive an RF signal as determined by an oscillator 413. The transmit circuitry 406 may be comprised of discrete devices or circuits, or alternately, may be comprised of an integrated assembly. An exemplary RF power output from the transmit coupler 414 may be on the order of 2.5 Watts.

Transmit circuitry 406 may further include a controller 415 for selectively enabling the oscillator 413 during transmit phases (or duty cycles) for specific receivers, for adjusting the frequency or phase of the oscillator 413, and for adjusting the output power level for implementing a communication protocol for interacting with neighboring devices through their attached receivers. It is noted that the controller 415 may also be referred to herein as a processor. Adjustment of oscillator phase and related circuitry in the transmission path may allow for reduction of out of band emissions, especially when transitioning from one frequency to another.

The transmit circuitry 406 may further include a load sensing circuit 416 for detecting the presence or absence of active receivers in the vicinity of the near-field generated by transmit coupler 414. By way of example, a load sensing circuit 416 monitors the current flowing to the driver circuit 424, that may be affected by the presence or absence of active receivers in the vicinity of the field generated by transmit coupler 414 as will be further described below. Detection of changes to the loading on the driver circuit 424 are monitored by controller 415 for use in determining whether to enable the oscillator 413 for transmitting energy and to communicate with an active receiver. As described more fully below, a current measured at the driver circuit 424 may be used to determine whether an invalid device is positioned within a wireless power transfer region of the transmitter 404.

The transmit coupler 414 may include a component including Litz wire or as an coupler strip with the thickness, width and metal type selected to keep resistive losses low. In a one implementation, the transmit coupler 414 may generally be configured for association with a larger structure such as a table, mat, lamp or other less portable configuration. A transmit coupler may also use a system of magneto-mechanical oscillators in accordance with some implementations described herein.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert AC power present in a building, a DC-DC converter (not shown) to convert a DC power source to a voltage suitable for the transmitter 404, or directly from a DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the RF power received by the device may be used to toggle a switch on the Rx device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some implementations, there may be regulations limiting the amount of power that a transmit coupler 414 may transmit at a specific frequency. In some cases, these regulations are meant to protect humans from electromagnetic radiation. However, there may be environments where a transmit coupler 414 is placed in areas not occupied by humans, or occupied infrequently by humans, such as, for example, garages, factory floors, shops, and the like. If these environments are free from humans, it may be permissible to increase the power output of the transmit coupler 414 above the normal power restrictions regulations. In other words, the controller 415 may adjust the power output of the transmit coupler 414 to a regulatory level or lower in response to human presence and adjust the power output of the transmit coupler 414 to a level above the regulatory level when a human is outside a regulatory distance from the electromagnetic field of the transmit coupler 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In implementations, a method by which the transmitter 404 does not remain on indefinitely may be used. In this case, the transmitter 404 may be programmed to shut off after a user-determined amount of time. This feature prevents the transmitter 404, notably the driver circuit 424, from running long after the wireless devices in its perimeter are fully charged. This event may be due to the failure of the circuit to detect the signal sent from either the repeater or the receive coupler 218 that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

FIG. 5 is a functional block diagram of a receiver 508 that may be used in the wireless power transfer system of FIG. 1, in accordance with some implementations of the invention. The receiver 508 includes receive circuitry 510 that may include a receive coupler 518. Receiver 508 further couples to device 550 for providing received power thereto. It should be noted that receiver 508 is illustrated as being external to device 550 but may be integrated into device 550. Energy may be propagated wirelessly to receive coupler 518 and then coupled through the rest of the receive circuitry 510 to device 550. By way of example, the charging device may include devices such as mobile phones, vehicles, portable music players, laptop computers, tablet computers, computer peripheral devices, communication devices (e.g., Bluetooth devices), digital cameras, hearing aids (and other medical devices), and the like.

Receive coupler 518 may be tuned to resonate at the same frequency, or within a specified range of frequencies, as transmit coupler 414 (FIG. 4). Receive coupler 518 may be similarly dimensioned with transmit coupler 414 or may be differently sized based upon the dimensions of the associated device 550. By way of example, device 550 may be a portable electronic device having diametric or length dimension smaller than the diameter or length of transmit coupler 414.

Receive circuitry 510 may provide an impedance match to the receive coupler 518. Receive circuitry 510 includes power conversion circuitry 506 for converting a received RF energy source into charging power for use by the device 550. Power conversion circuitry 506 includes an AC-to-DC converter 520 and may also include a DC-to-DC converter 522. AC-to-DC converter 520 rectifies the AC energy signal received at receive coupler 518 into a non-alternating power with an output voltage represented by V_{rect}. The DC-to-DC converter 522 (or other power regulator) converts the rectified AC energy signal into an energy potential (e.g., voltage) that is compatible with device 550 with an output voltage and output current. Various AC-to-DC converters are contemplated, including partial and full rectifiers, regulators, bridges, doublers, as well as linear and switching converters.

Receive circuitry 510 may further include switching circuitry 512 for connecting receive coupler 518 to the power conversion circuitry 506 or alternatively for disconnecting the power conversion circuitry 506. Disconnecting receive coupler 518 from power conversion circuitry 506 not only suspends charging of device 550, but also changes the “load” as “seen” by the transmitter 404 (FIG. 2).

As disclosed above, the transmitter 404 includes the load sensing circuit 416 that may detect fluctuations in the bias current provided to the driver circuit 424. Accordingly, transmitter 404 has a mechanism for determining when receivers are present in the transmitter's near-field.

When multiple receivers are present in a transmitter's near-field, it may be desirable to time-multiplex the loading and unloading of one or more receivers to enable other receivers to more efficiently couple to the transmitter. A receiver 508 may also be cloaked in order to eliminate coupling to other nearby receivers or to reduce loading on nearby transmitters. Furthermore, this switching between unloading and loading controlled by receiver 508 and detected by transmitter 404 may provide a communication mechanism from receiver 508 to transmitter 404 as is explained more fully below. Additionally, a protocol may be associated with the switching that enables the sending of a message from receiver 508 to transmitter 404.

In some implementations, communication between the transmitter 404 and the receiver 508 refers to a device sensing and charging control mechanism. In other words, the transmitter 404 may use on, off keying of the transmitted signal to adjust whether energy is available in the near-field. The receiver may interpret these changes in energy as a message from the transmitter 404. From the receiver side, the receiver 508 may use tuning and de-tuning of the receive coupler 518 to adjust how much power is being accepted from the field. In some cases, the tuning and de-tuning may be accomplished via the switching circuitry 512. The transmitter 404 may detect this difference in power used from the field and interpret these changes as a message from the receiver 508. It is noted that other forms of modulation of the transmit power and the load behavior may be utilized.

Receive circuitry 510 may further include signaling detector and beacon circuitry 514 used to identify received energy fluctuations that may correspond to informational signaling from the transmitter to the receiver. Furthermore, signaling and beacon circuitry 514 may also be used to detect the transmission of a reduced AC signal energy (i.e., a beacon signal) and to rectify the reduced AC signal energy into a nominal power for awakening either un-powered or power-depleted circuits within receive circuitry 510 in order to configure receive circuitry 510 for wireless charging.

Receive circuitry 510 further includes processor 516 for coordinating the processes of receiver 508 described herein including the control of switching circuitry 512 described herein. Processor 516may monitor beacon circuitry 514 to determine a beacon state and extract messages sent from the transmitter 404. Processor 516 may also adjust the DC-to-DC converter 522 for improved performance.

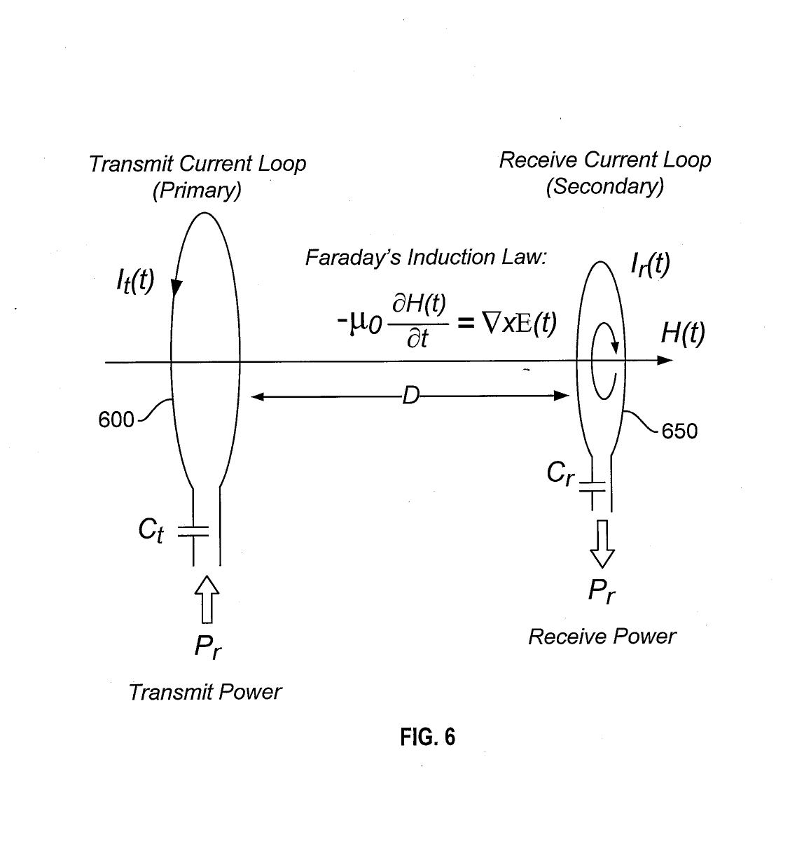

FIG. 6 illustrates non-radiative energy transfer that is based on Faraday's induction law, which may be expressed as:

$$- {μ}_{0} \frac{\partial H ( t )}{\partial t} = ∇ \times E ( t )$$

where ∇×E(t) denotes curl of the electric field generated by the alternating magnetic field. A transmitter forms a primary coupler (e.g., a transmit coupler as described above) and a receiver forms a secondary coupler (e.g., a receiver coupler as described above) separated by a transmission distance D. The primary coupler represents the transmit coupler generating an alternating magnetic field. The secondary coupler represents the receive coupler that extracts electrical power from the alternating magnetic field using Faraday's induction law.

The generally weak coupling that exists between the primary coupler and secondary coupler may be considered as a stray inductance. This stray inductance, in turn, increases the reactance, which itself may hamper the energy transfer between primary coupler and secondary coupler. The transfer efficiency of this kind of weakly coupled system may be improved by using capacitors that are tuned to the precise opposite of the reactance at the operating frequency. When a system is tuned in this way, it becomes a compensated transformer which is resonant at its operating frequency. The power transfer efficiency is then only limited by losses in the primary coupler and secondary coupler. These losses are themselves defined by their quality or Q-factors and the coupling factor between the primary coupler and the secondary coupler. Different tuning approaches may be used. Examples include, but are not limited to, compensation of the full reactance as seen at the primary coupler or secondary coupler (e.g., when either is open-circuited), and compensation of stray inductance. Compensation may also be considered as part of the source and load impedance matching in order to maximize the power transfer. Impedance matching in this way can hence increase the amount of power transfer.

As the distance D between the transmitter 600 and the receiver 650 increases, the efficiency of the transmission can decrease. At increased distances, larger loops, and/or larger Q-factors may be used to improve the efficiency. However, when these devices are incorporated into a portable device, the size of the loop, thus its coupling and its Q-factor, may be limited by the parameters of the portable device.

Efficiency may be improved by reducing coupler losses. In general, losses may be attributed to imperfectly conducting materials, and eddy currents in the proximity of the loop. At lower frequencies (e.g., such as less than 1 MHz), flux magnification materials such as ferrite materials may be used to artificially increase the size of the coupler. Eddy current losses may inherently be reduced by concentrating the magnetic field. Special kinds of wire can also be used to lower the resistance, such as stranded or Litz wire at low frequencies to mitigate skin effect.

A species of resonant inductive energy transfer uses a magneto-mechanical system as described herein. The magneto-mechanical system may be part of an energy receiving system that picks up energy from an alternating magnetic field, converts it to mechanical energy, and then reconverts that mechanical energy into electrical energy using Faraday's induction law.

According to an implementation, the magneto-mechanical system is formed of a magnetic element, e.g. a permanent magnetic element, which is mounted in a way that allows it to oscillate under the force of an external alternating magnetic field. This transforms energy from the magnetic field into mechanical energy. In an implementation, this oscillation uses rotational moment around an axis perpendicular to the vector of the magnetic dipole moment in, and is also positioned in the center of gravity of the magnetic element. This allows equilibrium and thus minimizes the effect of the gravitational force. A magnetic field applied to this system produces a torque T=μ₀(m×H). This torque tends to align the magnetic dipole moment of the elementary magnetic element along the direction of the field vector. Assuming an alternating magnetic field, the torque accelerates the moving magnet(s), thereby transforming the oscillating magnetic energy into mechanical energy.

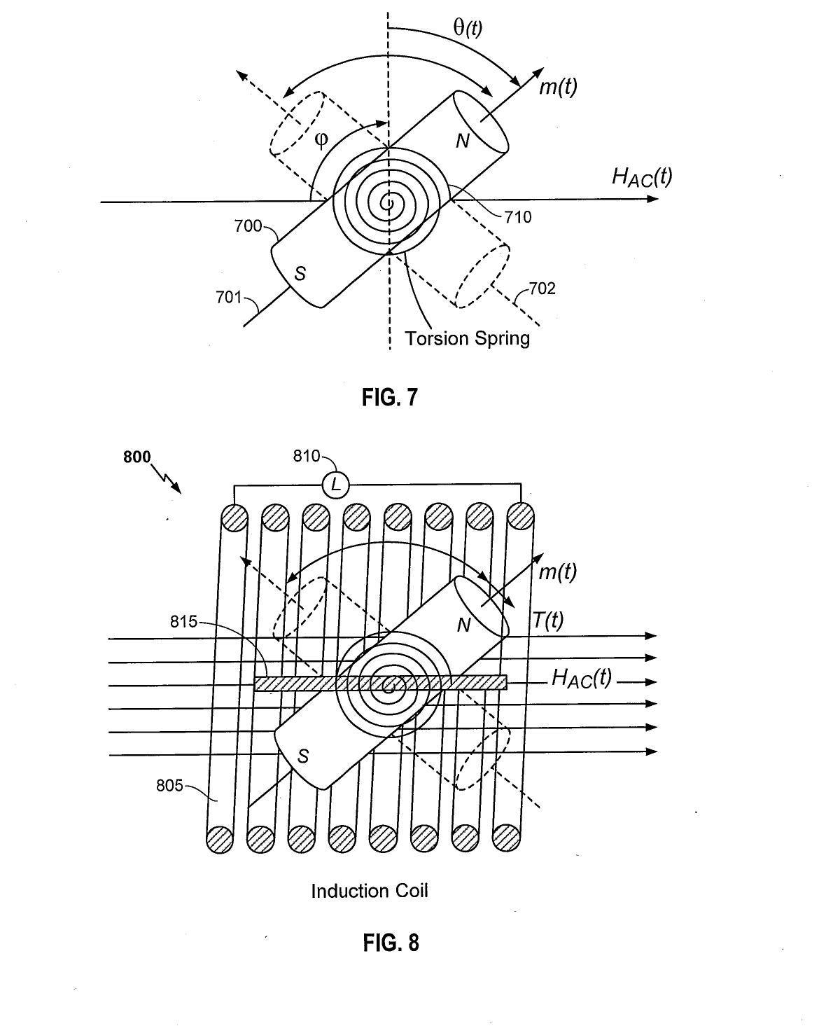

For example, in some implementations, a transmit coupler, e.g., as shown in any of FIGS. 1-4, may be utilized to generate a time-varying exciting magnetic field that may cause one or more first magneto-mechanical oscillators, as will be described below, to physically oscillate. Such physical oscillation of magnetic elements within the first magneto-mechanical oscillators may cause the first magneto-mechanical oscillators themselves to further generate a second time-varying excited magnetic field at substantially the same frequency as the first time-varying magnetic field. Thus, each magneto-mechanical oscillator of the plurality of magneto-mechanical oscillators is configured to resonate at a frequency of the first time-varying magnetic field. In some implementations, this excited magnetic field may cause one or more second magneto-mechanical oscillators at a distance from the first oscillators to physically oscillate at the frequency of the excited magnetic field generated by the first oscillators, which in turn, causes magnetic elements within the second oscillators to generate an excited magnetic field at that frequency. A receive coupler, e.g., as shown in any of FIGS. 1-3, and 5, located near or around the second oscillators may generate an alternating current under the influence of the excited magnetic field generated by the second oscillators. The operation of such systems will be described in more detail in connection with FIGS. 7-21 below.

FIG. 7 schematically illustrates an example magneto-mechanical oscillator, in accordance with some implementations. The magneto-mechanical oscillator of FIG. 7 comprises a magnetic element 700 having a magnetic moment m(t) (e.g., a vector having a constant magnitude but an angle that is time-varying, such as a magnetic dipole moment) and the magnetic element 700 is mechanically coupled to an underlying substrate (not shown) by at least one spring (e.g., a torsion spring 710). This spring holds the magnetic element in position shown as 701 when no torque from the magnetic field is applied. This no-torque position 701 is considered 0. Magnetic torque causes the magnetic element 700 to move against the restoring force of the torsion spring 710, to the position 702, against the force of the spring with spring constant K_{R}. The magneto-Mechanical oscillator may be considered a torsion pendulum with an inertial moment I and exhibiting a resonance at a frequency proportional to K_{R} and I. Frictional losses and in most cases a very weak electromagnetic radiation is caused by the oscillating magnetic moment. If this magneto-mechanical oscillator is subjected to an alternating field H_{AC}(t) with a frequency near the resonance frequency of the magneto-mechanical oscillator, then the magneto-mechanical oscillator will oscillate with an angular displacement θ(t) depending on the intensity of the applied magnetic field and reaching a maximum, peak displacement at resonance.

In such implementations, the torsion spring 710 is used to stabilize the magnetic element 700. This may have several disadvantages. First, the mechanical force of the torsion spring 710 may reduce coupling between the transmitter and the receiver. Second, even when the springs are strong enough to stabilize the arrangement of the magneto-mechanical oscillators, small residual static displacements of the magnetic element 700 may remain and be non-uniformly distributed over the array which may lead to unfavorable dynamics. Third, if the array of magneto-mechanical oscillators is stabilized by respective torsion springs 710 the non-linear magnetic dipole interaction will be dominated by the generally linear torque of the torsion spring 710. Non-linear hysteresis effects and frequency broadening, which may be favorable for applications in wireless power transfer or other fields, may be lost. Fourth, such torsion springs 710 inevitably lead to mechanical losses, which reduces the Q factor of the magneto-mechanical oscillator. Therefore, it is desirable to attribute as little volume as possible to the torsion spring 710, or eliminate it altogether. These disadvantages may be alleviated using self-stabilizing arrays of magneto-mechanical oscillators solely on the basis of the interactions between the magnetic elements as described below.

According to another implementation, some or all of the restoring force of the spring may be replaced by an additional static magnetic field H₀. This static magnetic field may be oriented to provide the torque T₀=μ₀(m×H₀). Another implementation may use both the spring and a static magnetic field to produce the restoring force of the magneto-mechanical oscillator. The mechanical energy is reconverted into electrical energy using Faraday induction, e.g. the dynamo principle. This may be used for example an induction coil 805 wound around the magneto-electrical system 800 as shown in FIG. 8. In another example, the mechanical energy is reconverted into electrical energy using another type of circuit configured to directly convert the mechanical motion into electrical power or otherwise couple energy from the magnetic field generated by the moving magnets. A load such as 810 may be connected across the coil 805. This load appears as a mechanical torque dampening the system and lowering the Q-factor of the magneto-mechanical oscillator. In addition, when magnetic elements are oscillating and thus generating a strong alternating magnetic field component and if the magnetic elements are electrically conducting, eddy currents in the magnetic elements will occur. These eddy currents will also contribute to system losses.

In general, some eddy currents may be also produced by the alternating magnetic field that results from the current in the coupling coil. Smaller magnetic elements in the magneto-mechanical system may reduce eddy current effects. According to an implementation, an array of smaller magnetic elements is used in order to minimize this loss effect.

A magneto-mechanical system will exhibit saturation if the angular displacement of the magnetic element reaches a peak value. This peak value may be determined from the direction and intensity of the external H field or by the presence of a displacement stopper such as 815 to protect the torsion spring against plastic deformation. This may also be limited by the packaging, such as the limited available space for a magnetic element to rotate within. Electric breaking by modifying the electric loading may be considered an alternative method to control saturation and thus prevent damaging the magneto-mechanical system.

According to one implementation and assuming a loosely coupled regime (e.g., weak coupling, such as in the case of energy harvesting from an external magnetic field generated by a large loop antenna surrounding a large space), optimum matching may be obtained when the loaded Q becomes half of the unloaded Q. According to an implementation, the induction coil is designed to fulfill that condition to maximize the amount of output power. If coupling between transmitter and receiver is stronger (e.g., a tightly coupled regime), optimum matching may utilize a loaded Q that is significantly smaller than the unloaded Q.

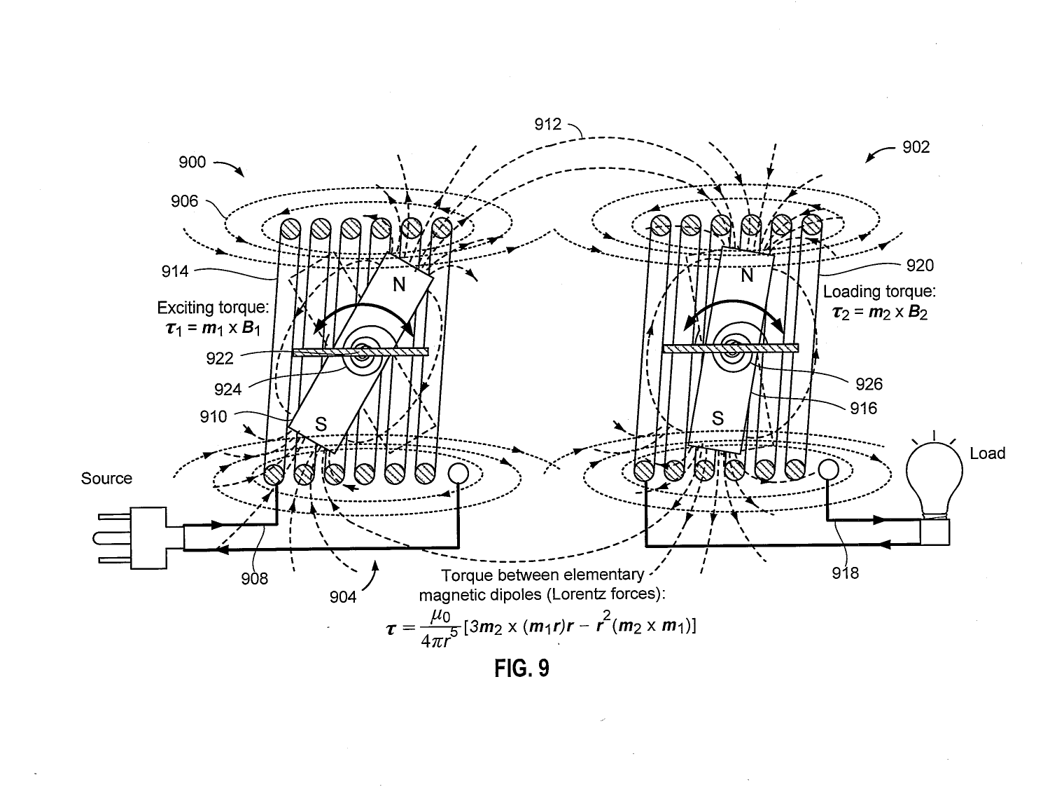

FIG. 9 schematically illustrates an example power transmitter 900 configured to wirelessly transfer power to at least one power receiver 902, in accordance with some implementations. The power transmitter 900 comprises at least one excitation circuit 904 configured to generate a first time-varying (e.g., alternating) magnetic field 906 in response to a time-varying (e.g., alternating) electric current 908 flowing through the at least one excitation circuit 904. The first time-varying magnetic field 906 has an excitation frequency. The power transmitter 900 further comprises a plurality of magneto-mechanical oscillators 910 (e.g., that are mechanically coupled to at least one substrate, which is not shown in FIG. 9). FIG. 9 schematically illustrates one example magneto-mechanical oscillator 910 compatible with certain implementations described herein for simplicity, rather than showing the plurality of magneto-mechanical oscillators 910. Each magneto-mechanical oscillator 910 of the plurality of magneto-mechanical oscillators has a mechanical resonant frequency substantially equal to the excitation frequency. The plurality of magneto-mechanical oscillators 910 is configured to generate a second time-varying (e.g., alternating) magnetic field 912 in response to movement of the plurality of magneto-mechanical oscillators 910 under the influence of the first time-varying magnetic field 906.

As schematically illustrated by FIG. 9, the at least one excitation circuit 904 comprises at least one coil 914 surrounding (e.g., encircling) at least a portion of the plurality of magneto-mechanical oscillators 910. The at least one coil 914 has a time-varying (e.g., alternating) electric current 908 I₁(t) flowing through the at least one coil 914, and generates a time-varying (e.g., alternating) first time-varying magnetic field 906 which applies a torque (labeled as “exciting torque” in FIG. 9) to the magneto-mechanical oscillators 910. Although the coil 914 is shown, the present application is not so limited and other types of excitation circuits capable of generating a time varying magnetic field for inducing motion of the magneto-mechanical oscillators are also contemplated. In response to the first time-varying magnetic field 906, the magneto-mechanical oscillators 910 rotate about an axis. In this way, the at least one excitation circuit 904 and the plurality of magneto-mechanical oscillators 910 convert electrical energy into mechanical energy. The magneto-mechanical oscillators 910 generate a second time-varying magnetic field 912 which wirelessly transmits power to the power receiver 902 (e.g., a power receiver as described above). For example, the power receiver 902 can comprise a receiving plurality of magneto-mechanical oscillators 916 configured to rotate in response to a torque applied by the second time-varying magnetic field 912 and to induce a current 918 in a pick-up coil 920 (e.g., a power extraction circuit), thereby converting mechanical energy into electrical energy. Although the pick-up coil 920 is shown, the present application is not so limited and any power extraction circuit configured to convert the mechanical energy into electrical energy for powering a load is also contemplated.

As schematically illustrated by FIG. 9 for a pick-up coil for a power transmitter utilizing a plurality of magneto-mechanical oscillators, the at least one coil 914 of the power transmitter 900 can comprise a single common coil that is wound around at least a portion of the plurality of magneto-mechanical oscillators 910 of the power transmitter 900. The wires of the at least one coil 914 may be oriented substantially perpendicular to the “dynamic” component (described in more detail below) of the magnetic moment of the plurality of magneto-mechanical oscillators 910 to advantageously improve (e.g., maximize) coupling between the at least one coil 914 and the plurality of magneto-mechanical oscillators 910. As described more fully below, the excitation current flowing through the at least one coil 914 may be significantly lower than those used in other resonant induction systems. Thus, certain implementations described herein advantageously do not have special requirements for the design of the at least one coil 914.

As described above with regard to FIG. 9 for the magneto-mechanical oscillators of a power receiver, the magneto-mechanical oscillators 910 of the power transmitter 900, in accordance with some implementations may be MEMS structures fabricated on at least one substrate (e.g., a semiconductor substrate, a silicon wafer) using lithographic processes such as are known from MEMS fabrication techniques. Each magneto-mechanical oscillator 910 of the plurality of magneto-mechanical oscillators 910 can comprise a movable magnetic element configured to rotate about an axis 922 in response to a torque applied to the movable magnetic element by the first time-varying magnetic field 906. The movable magnetic element may comprise a spring 924 (e.g., torsion spring, compression spring, extension spring) mechanically coupled to the substrate and configured to apply a restoring force to the movable magnetic element in response to rotation of the movable magnetic element. In other implementations, no spring may be present. The magneto-mechanical oscillators 916 of the power receiver 902 can comprise a movable magnetic element (e.g., magnetic dipole) comprising a spring 926 (e.g., torsion spring, compression spring, extension spring) mechanically coupled to a substrate of the power receiver 902 and configured to apply a restoring force to the movable magnetic element in response to rotation of the movable magnetic element. In other implementations, no spring may be present.

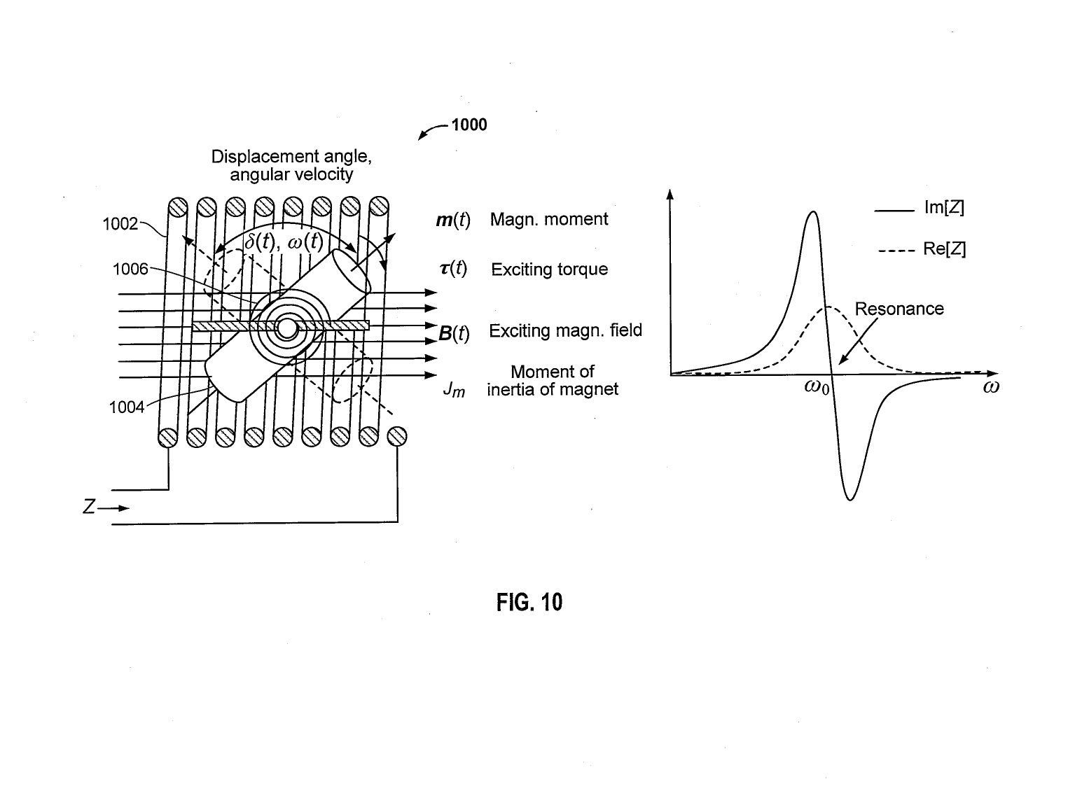

FIG. 10 schematically illustrates an example power transmitter 1000, in accordance with some implementations in which the at least one excitation circuit 1002 is driven at a frequency substantially equal to a mechanical resonant frequency of the magneto-mechanical oscillators 1004. The at least one excitation circuit 1002 generates the first time-varying magnetic field which applies the exciting torque to the magneto-mechanical oscillator 1004, which has a magnetic moment and a moment of inertia. The direction of the magnetic moment is time-varying, but its magnitude is constant. The resonant frequency of a magneto-mechanical oscillator 1004 is determined by the mechanical properties of the magneto-mechanical oscillator 1004, including its moment of inertia (a function of its size and dimensions) and spring constants.

The input impedance of the at least one excitation circuit 1002 has a real component and an imaginary component, both of which vary as a function of frequency. Near the resonant frequency of the magneto-mechanical oscillators 1004, the real component is at a maximum, and the imaginary component disappears (e.g., is substantially equal to zero) (e.g., the current and voltage of the at least one excitation circuit 1002 are in phase with one another). At this frequency, the impedance, as seen at the terminals of the at least one coil, appears as purely resistive, even though a strong alternating magnetic field may be generated by the magneto-mechanical oscillators. The combination of the at least one excitation circuit 1002 and the plurality of magneto-mechanical oscillators 1004 can appear as an “inductance-less inductor” which advantageously avoids (e.g., eliminates) the need for resonance-tuning capacitors as are used in other power transmitters.

Since the time-varying (e.g., alternating) second time-varying magnetic field is generated by the plurality of magneto-mechanical oscillators 1004, there are no high currents flowing through the electrical conductors of the at least one excitation circuit 1002 at resonance, such as exist in other resonant induction systems. Therefore, losses in the at least one excitation circuit 1002 (e.g., the exciter coil) may be negligible. In certain such configurations, thin wire or standard wire may be used in the at least one excitation circuit 1002, rather than Litz wire. The main losses occur in the plurality of magneto-mechanical oscillators 1004 and its surroundings due to mechanical friction, air resistance, eddy currents, and radiation in general. The magneto-mechanical oscillators 1004 can have Q-factors which largely exceed those of electrical resonators, particularly in the kHz and MHz ranges of frequencies. For example, the Q-factor of the plurality of magneto-mechanical oscillators 1004 (either in use for a transmitter system or a receiver system) may be greater than 500, or even greater than 10,000. Such high Q-factors may be more difficult to achieve in other resonant induction systems using capacitively loaded wire loops in some cases. However, in a weakly coupled regime, the energy transfer efficiency increases proportionally to the Q-factor, to the square of the magnetization, and inversely proportional to a density of a moment of inertia Jₘ. Thus, maximum transferable power, which is limited by saturation effects, increases proportional to the frequency, to the square of the product of magnetic moments, and to the peak angular displacement of the magnets.

The large Q-factor of certain implementations described herein can also be provided by the plurality of magneto-mechanical oscillators 1004. The power that may be wirelessly transmitted to a load is the product of the root-mean-square (RMS) values of the torque τ_{RMS} applied to the magneto-mechanical oscillator 1004 and the frequency (e.g., angular velocity) ω_{RMS}. To allow for sufficient oscillation (e.g., sufficient angular displacement of the magneto-mechanical oscillator 1004) when power transfer distances increase, the torque τ_{RMS} (e.g., the dampening torque applied to the magneto-mechanical oscillator 1004 of a power transmitter 1000, or the loading torque applied to the magneto-mechanical oscillator of a power receiver) may be reduced, but such increased distances result in lower power. This power loss may be compensated for by increasing the frequency ω_{RMS}, within the limits given by the moment of inertia of the magneto-mechanical oscillators 1004 and the torsion springs 1006. The performance of the magneto-mechanical oscillator 1004 may be expressed as a function of the gyromagnetic ratio

$$γ = \frac{m}{{J}_{m}}$$

(where m is the magnetic moment of the magneto-mechanical oscillator 1004, and Jₘ is the moment of inertia of the magneto-mechanical oscillator 1004), and this ratio can advantageously be configured to be sufficiently high to produce sufficient performance at higher frequencies.

A plurality of small, individually oscillating magneto-mechanical oscillators arranged in a regular three-dimensional array can advantageously be used in a transmitter or receiver, instead of a single permanent magnetic element. The plurality of magneto-mechanical oscillators can have a larger gyromagnetic ratio than a single permanent magnetic element having the same total volume and mass as the plurality of magneto-mechanical oscillators. The gyromagnetic ratio of a three-dimensional array of N magneto-mechanical oscillators with a sum magnetic moment m and a sum mass Mₘ may be expressed as:

$$γ ( N ) = \frac{12 \cdot N \cdot \frac{m}{N}}{\frac{{NM}_{m}}{N} {( \frac{{l}_{m}}{\sqrt[3]{N}} )}^{2}} = \frac{12 m}{{M}_{m} {l}_{m}^{2}} {\sqrt[3]{N}}^{2}$$

where lₘ denotes the length of an equivalent single magnetic element (N=1).

This equation shows that the gyromagnetic ratio increases to the power of ⅔ with decreasing size of the magneto-mechanical oscillators. In other words, a large magnetic moment produced by an array of small magneto-mechanical oscillators may be accelerated and set into oscillation by a faint torque (e.g., the exciting torque produced by a small excitation current flowing through the at least one excitation current of a power transmitter or the loading torque in a power receiver produced by a distant power transmitter). The performance of the plurality of magneto-mechanical oscillators may be increased by increasing the number of magneto-mechanical oscillators since the magnetic moment increases more than does the moment of inertia by increasing the number of magneto-mechanical oscillators. Using an array of magneto-mechanical oscillators (e.g., with features size in the micron range), resonant frequencies far into the MHz range may be used.

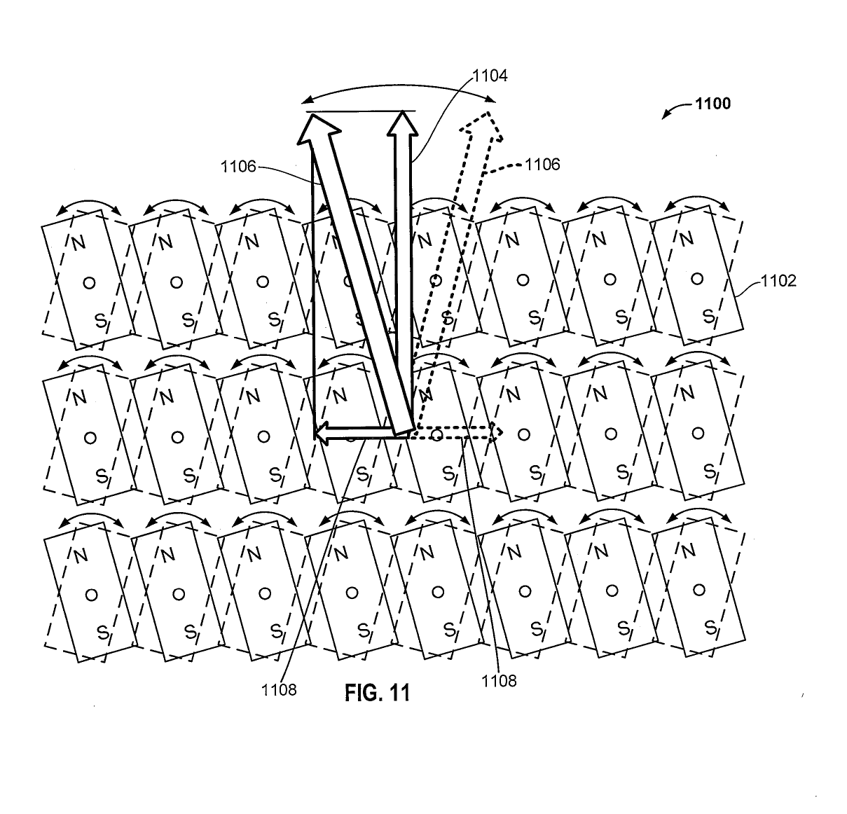

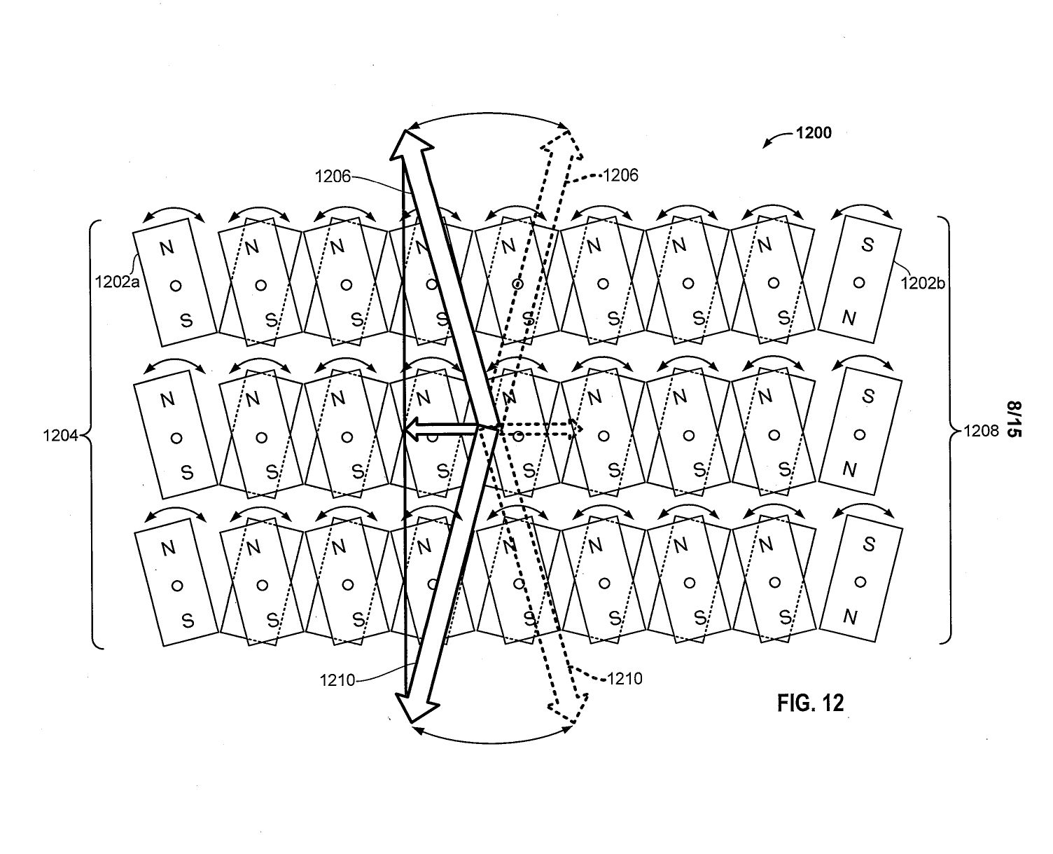

FIG. 11 schematically illustrates an example portion 1100 of a configuration of a plurality of magneto-mechanical oscillators 1102, in accordance with some implementations. The portion 1100 shown in FIG. 11 comprises a set of magneto-mechanical oscillators 1102. This arrangement of magneto-mechanical oscillators 1102 in a regular structure is similar to that of a plane in an atomic lattice structure (e.g., a three-dimensional crystal).

The oscillation of the magneto-mechanical oscillators 1102 between the solid positions and the dashed positions produces a sum magnetic moment that may be decomposed into a “quasi-static” component 1104 (denoted in FIG. 11 by the vertical solid arrow) and a “dynamic” component 1106 (denoted in FIG. 11 by the solid and dashed arrows at an angle to the vertical, and having a horizontal component 1108 shown by solid and dashed arrows). The dynamic component 1106 is responsible for energy transfer. For an example configuration such as shown in FIG. 11, for a maximum angular displacement of 30 degrees, a volume utilization factor of 15% for the set of magneto-mechanical oscillators 1102, a rare-earth metal magnetic material having 1.6 Tesla at its surface, a “dynamic” flux density in the order of 110 milli-Tesla peak may be achieved virtually without hysteresis losses, thereby outperforming certain other ferrite technologies.

However, the quasi-static component 1104 may be of no value in the energy transfer. In fact, in practical applications, it may be desirable to avoid (e.g., lessen or eliminate) the quasi-static component 1104, since it results in a strong magnetization (e.g., such as that of a strong permanent magnet) that can attract any magnetic materials in the vicinity of the structure towards the plurality of magneto-mechanical oscillators 1102.

The sum magnetic field generated by the plurality of magneto-mechanical oscillators 1102 can cause the individual magneto-mechanical oscillators 1102 to experience a torque such that they rest at a non-zero displacement angle. These forces may also change the effective torsion spring constant, thus modifying the resonant frequency.

FIG. 12 schematically illustrates an example configuration in which the plurality of magneto-mechanical oscillators 1202 is arranged in a three-dimensional array 1200 in which the quasi-static components of various portions of the plurality of magneto-mechanical oscillators 1202 cancel one another, in accordance with some implementations. The three-dimensional array 1200 of FIG. 12 comprises at least one first plane 1204 (e.g., a first layer) comprising a first set of magneto-mechanical oscillators 1202a of the plurality of magneto-mechanical oscillators 1202, with each magneto-mechanical oscillator 1202a of the first set of magneto-mechanical oscillators 1202a having a magnetic moment pointing in a first direction. The first set of magneto-mechanical oscillators 1202a has a first summed magnetic moment 1206 (denoted in FIG. 12 by the top solid and dashed arrows) comprising a time-varying component and a time-invariant component. The three-dimensional array 1200 further comprises at least one second plane 1208 (e.g., a second layer) comprising a second set of magneto-mechanical oscillators 1202b of the plurality of magneto-mechanical oscillators 1202. Each magneto-mechanical oscillator 1202b of the second set of magneto-mechanical oscillators 1202b has a magnetic moment pointing in a second direction. The second set of magneto-mechanical oscillators 1202b has a second summed magnetic moment 1210 (denoted in FIG. 12 by the bottom solid and dashed arrows) comprising a time-varying component and a time-invariant component. The time-invariant component of the first summed magnetic moment 1206 and the time-invariant component of the second summed magnetic moment 1210 have substantially equal magnitudes as one another and point in substantially opposite directions as one another. In this way, the quasi-static components of the magnetic moments of the first set of magneto-mechanical oscillators 1202a and the second set of magneto-mechanical oscillators 1202b cancel one another out (e.g., by having the polarities of the magneto-mechanical oscillators alternate between adjacent planes of a three-dimensional array 1200). In contrast, the time-varying components of the first summed magnetic moment 1206 and the second summed magnetic moment 1210 have substantially equal magnitudes as one another and point in substantially the same direction as one another.

The structure of FIG. 12 is analogous to the structure of paramagnetic materials that have magnetic properties (e.g., a relative permeability greater than one) but that cannot be magnetized (e.g., soft ferrites). Such an array configuration may be advantageous, but can produce a counter-torque acting against the torque produced by an external magnetic field on the magneto-mechanical oscillators. This counter-torque will be generally added to the torque of the torsion spring. This counter-torque may be used as a restoring force to supplement that of the torsion spring or to be used in the absence of a torsion spring in the magneto-mechanical oscillator. In addition, the counter-torque may reduce the degrees of freedom in configuring the plurality of magneto-mechanical oscillators.

In order to provide an aggregate alternating magnetic field having sufficient strength to wirelessly transfer power it is desirable that each magnetic element of each magneto-mechanical oscillator have a similar orientation at rest. In some implementations this similar orientation is provided by a restoring force of a spring or torsional beam. However, tradeoffs of relying on springs or torsional beams for such a restoring force is reduced efficiency and reduced Q-factor of the array of magneto-mechanical oscillators caused by the mechanical loading provided by the springs or torsional beams. Thus some implementations of the present application contemplate spatial arrangements of a plurality of magneto-mechanical oscillators that provide such a restoring force to the magnetic elements, optimizing a static magnetic field produced by the plurality of magneto-mechanical oscillators, rather than the restoring force being solely or partially provided by a spring or torsional beam. Such implementations allow relaxed design constraints on any support structures that restrict oscillation of the magnetic elements or may even eliminate a requirement for them.

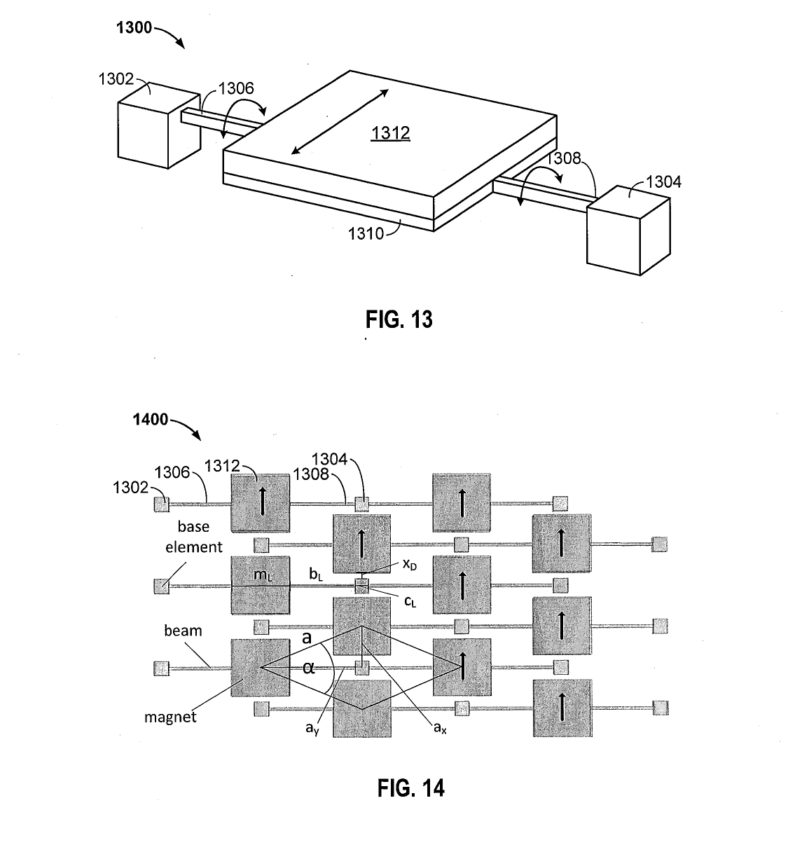

FIG. 13 illustrates a magneto-mechanical oscillator 1300, in accordance with some implementations. The magneto-mechanical oscillator 1300 may be incorporated as part of an array of magneto-mechanical oscillators as described above and further below. The magneto-mechanical oscillator 1300, as well as any of the other implementations described below, may be used as part of a wireless power receiver device or a wireless power transmission device. As shown in FIG. 13, the magneto-mechanical oscillator 1300 comprises a first base support element 1302, a second base support element 1304, a first beam 1306 connected to the first base support element 1302, a second beam 1308 connected to the second base support element 1304, a holder 1310 (e.g., a substrate or other material to which one or more additional materials or layers may be attached) connected to each of the first beam 1306 and second beam 1308 and a magnetic element 1312 disposed on the holder 1310 such that the holder 1310 supports or is supporting the magnetic element 1312. In some implementations, the magnetic element 1312 is a permanent magnet. In some implementations the holder 1310 may be referred to as or configured as a carrier.

Although shown having a substantially square or rectangular cross-section, the first beam 1306 and second beam 1308 may have a substantially circular cross-section, which may provide a more uniform strain within the first beam 1306 and the second beam 1308 as well as increase the Q-factor of the oscillator 1300. Moreover, by rounding the edges of the first beam 1306 and second beam 1308, a mechanical stress at the connection points between the first beam 1306 and second beam 1308 and either of the first base support element 1302, the second base support element 1304 or the holder 1310 may be reduced. The magnetic element 1312 and the holder 1310 material may be chosen for good adhesion to one another. Each of the first base support element 1302 and second base support element 1304 may be structurally fixed to a substrate (not shown in FIG. 13).

The holder 1310 and the magnetic element 1312 may be configured to oscillate about a fixed axis defined through the long direction of extension of the first beam 1306 and second beam 1308, as shown by the arrows. For this reason, the magnetic element 1312 and/or the holder 1310 may be considered “moveable” or “rotatable.” The use of the first base support element 1302 and second base support element 1304 provides a physical offset of the first beam 1306 and second beam 1308, the holder 1310 and the magnetic element 1312 from a substrate (not shown) such that the holder 1310 and the magnetic element 1312 may be deflected at larger angles, with respect to a resting position, without the holder 1310 and/or magnetic element 1312 contacting the substrate and causing damage. In order to achieve the highest degree of coupling to an external magnetic field that excites the oscillator 1300, the magnetic element 1312 may be magnetized in a direction perpendicular to the first beam 1306 and second beam 1308 and in a plane defined by the holder 1310, as shown by the arrow on the magnetic element 1312.

In at least some implementations, the first base support element 1302 and second base support element 1304, the first beam 1306 and second beam 1308, and the holder 1310 may be formed from the same material, e.g., from silicon, so that a single structuring process may be utilized and sufficient mechanical stability may be achieved. The magnetic element 1312 may then be deposited on the holder 1310. The dimensions of the holder 1310, magnetic element 1312, and the first beam 1306 and the second beam 1308 may be determined to optimize (e.g., increase as much as possible or practical) the fill factor of the magnetic element 1312 with respect to the dimensions of the oscillator 1300, to provide a desired mechanical resonance frequency of the oscillator 1300, and/or to increase mechanical stability and resilience to stress of the oscillator 1300.

In some implementations, the first beam 1306 and the second beam 1308 may be replaced by some other form of a fixing element (not shown), which may comprise a wire or one or more bearings, for example, configured to constrain the magnetic element 1312 and the holder 1310 to rotate about a fixed axis. Thus, the present application contemplates any implementations having some sort of fixing element or structure that constrains at least the magnetic element 1312 to rotate about a fixed axis.

FIG. 14 illustrates a 2-dimensional nested array 1400 of the magneto-mechanical oscillators 1300 of FIG. 13, in accordance with some implementations. The numerals are the same as shown in FIG. 13. A plurality of magneto-mechanical oscillators 1300 are shown. Each magnetic element 1312 is shown as having a square cross section with side length m_{L}. Each of the first beam 1306 and the second beam 1308 has a length b_{L}. Each of the first base support element 1302 and the second base support element 1304 is a square having side length c_{L}. A straight-line distance from the edge of one of the first base support element 1302 and the second base support element 1304 in a row to an edge of the magnetic element 1312 of a magneto-mechanical oscillator 1300 in an adjacent nested row is x_{D}. A straight-line distance from the center of a row of magneto-mechanical oscillators 1300 to a center of an adjacent nested row of magneto-mechanical oscillators 1300 is aₓ. A lateral distance from the center of a magnetic element 1312 of a magneto-mechanical oscillator 1300 in one row to a center of a magnetic element 1312 of a magneto-mechanical oscillator 1300 in an adjacent nested row is a_{y}. The straight-line distance from the center of a magnetic element 1312 of a magneto-mechanical oscillator 1300 in one row to a center of a magnetic element 1312 of a magneto-mechanical oscillator 1300 in an adjacent nested row is the lattice constant a. The angle between lines connecting the center of one magneto-mechanical oscillator 1300 in one row to the center of the closest magneto-mechanical oscillator 1300 in each adjacent row is the lattice angle α. Thus, using trigonometry, we can determine the values for the lattice angle α as well as for the lattice constant a based on the following equations:

$$tan \frac{α}{2} = \frac{{a}_{x}}{{a}_{y}} = \frac{\frac{{m}_{L}}{2} + \frac{{c}_{L}}{2} + {x}_{D}}{\frac{{m}_{L}}{2} + \frac{{c}_{L}}{2} + {b}_{L}}$$

$$a = \sqrt{{a}_{x}^{2} + {a}_{y}^{2}} = \sqrt{{( \frac{{m}_{L}}{2} + \frac{{c}_{L}}{2} + {x}_{D} )}^{2} + {( \frac{{m}_{L}}{2} + \frac{{c}_{L}}{2} + {b}_{L} )}^{2}}$$

Designing the array for a preferable angle α may proceed by deciding on m_{L}, c_{L} and x_{D}, e.g. based on considerations about the desired resonance frequency of the magneto-mechanical oscillators, and then determining b_{L} for a given preferable angle a from the relations above. As an example, a set of geometric values is given that implements the proposed value of α=45°: m_{L}=100 μm, c_{L}=25 μm, x_{D}=10 μm and b_{L}=112.5 μm. The thickness and width of the first beam 1306 and the second beam 1308 no longer provide a substantial or primary stabilizing force against rotational displacements of the magnetic element 1312 but only fix the magnetic element 1312 in position. Thus, they can be made as soft as desired.

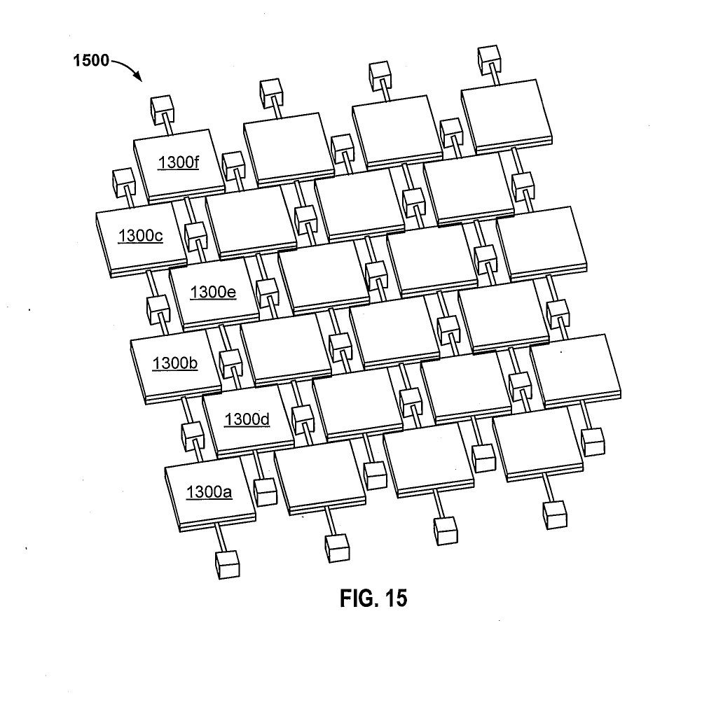

FIG. 15 illustrates a 2-dimensional nested array 1500 of the magneto-mechanical oscillators 1300 of FIG. 13, in accordance with some implementations. As shown in FIG. 15, the nested array 1500 may comprise a plurality of magneto-mechanical oscillators 1300a-1300f aligned into a plurality of nested rows of magneto-mechanical oscillators. The nested rows may be offset from one another. In some implementations, the magneto-mechanical oscillators 1300a-1300f may be substantially identical to one another in order to resonate substantially at the same natural frequency, considering fabrication tolerances. The nested arrangement allows the use of empty space between magnetic elements (and holders) of a particular nested row of magneto-mechanical oscillators for base support elements and beams of an adjacent row of magneto-mechanical oscillators. For example, oscillators within a particular row (e.g., magneto-mechanical oscillators 1300a-1300c) may be offset in a direction parallel to the axis of oscillation by approximately half of a pitch of an oscillator. In this way, the holder and magnetic element of magneto-mechanical oscillators in a particular row of magneto-mechanical oscillators may be immediately adjacent to (e.g., nested by) the base support elements and beams of magneto-mechanical oscillators in an immediately adjacent row of magneto-mechanical oscillators. In order to minimize frictional forces and thus increase the Q-factor of the array 1500, the empty space between individual oscillators may be quasi-evacuated of air or may be filled with a special gas at low pressure (e.g., inert gases such as nitrogen or xenon).

As previously described in connection with FIG. 13, each of the magneto-mechanical oscillators may have a direction of magnetization perpendicular to the axis of oscillation, and may be either substantially in the plane of the holder or substantially perpendicular to the plane of the holder. Moreover, depending on the particular implementation, the direction of magnetization may be the same for all oscillators in the array 1500 (e.g., a ferromagnetic arrangement), the direction of magnetization may alternate directions for adjacent oscillators (e.g., an anti-ferromagnetic arrangement) such that the array 1500 may exhibit a substantially zero aggregate magnetic field component a certain distance from the array 1500, or the direction of magnetization of the magneto-mechanical oscillators may be random (e.g., a paramagnetic arrangement) such that the aggregate magnetic field component will statistically cancel out across the entire array 1500, at the certain distance from the array 1500.

The present application is directed to implementations for optimizing the lattice structure of arrays of the magneto-mechanical oscillators 1300 in order to favorably influence the properties of the array for wireless power transfer applications in terms of both stability and resonance frequency. Aspects of certain implementations include anisotropic arrangements of the magneto-mechanical oscillators 1300, which are self-stabilized due to the sum of all magnetic interactions of the magnets with each other resulting in a net torque that restores the magnets to their desired equilibrium position. Of the proposed self-stabilized structures, the ones maintaining the highest packing densities are particularly suitable for wireless power transfer applications.

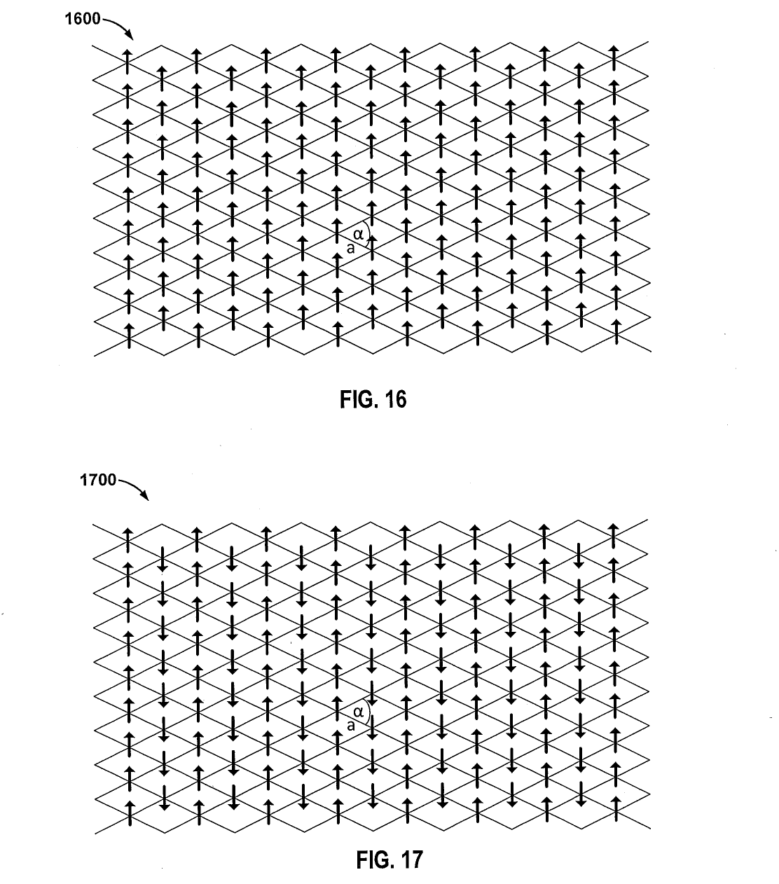

FIG. 16 illustrates a 2-dimensional nested array 1600 of the magneto-mechanical oscillators 1300 of FIG. 13, in accordance with some implementations. Each corner of the array 1600 indicates the location of a magneto-mechanical oscillator 1300. Stable arrays 1600 of the magneto-mechanical oscillators 1300 are obtained by arranging the magneto-mechanical oscillators 1300 in lines with the magnetization of the magnetic elements 1312 in the direction of the line, as indicated by the arrows at each corner. The direction of magnetization is the same for each magneto-mechanical oscillator 1300 in the array 1600. Such a line is a stable configuration. The term line should be understood in the sense that every magneto-mechanical oscillator 1300 has two nearest neighbors, having a shortest distance between them compared to all other neighbors, such that there exists an arbitrarily long line that virtually connects the magneto-mechanical oscillators 1300 in that line.

A restoring torque will act on every magnetic element 1312 when it is rotationally displaced. This property is conserved when multiple one-dimensional lines of magnetic elements 1312 are used to build two-dimensional arrays of magneto-mechanical oscillators 1300 as long as the distance between adjacent lines, as defined above, is large enough. The same principle applies to three-dimensional arrays, which can also be built from multiple lines of magneto-mechanical oscillators 1300 (see FIG. 18).

To further quantify the distances to stabilize two-dimensional and three-dimensional arrays, the present application contemplates two-dimensional rhombic lattices. The magneto-mechanical oscillators 1300 of each line are offset from the magneto-mechanical oscillators 1300 of each adjacent line by approximately half of the shortest distance between magneto-mechanical oscillators 1300 in the same line. In some implementations, this would mean that every other line of magneto-mechanical oscillators 1300 are aligned with one another. A lattice constant a is a distance between magneto-mechanical oscillators 1300 in one line and a nearest magneto-mechanical oscillator 1300 in an immediately adjacent line. Thus, the rhombic lattice comprises a plurality of nested rows of magneto-mechanical oscillators 1300 such that magneto-mechanical oscillators 1300 in a nested row are disposed in spaces between adjacent magneto-mechanical oscillators 1300 in an adjacent nested row.

A two-dimensional rhombic lattice of magneto-mechanical oscillators 1300 is stable even without mechanical springs for any lattice angle α≦55°, as determined by computer simulations. In order to maintain sufficiently close packing of the magnets, lattice angles α between 30° and 55°, and more particularly 45°, are proposed as particularly suitable for self-stabilized 2D arrays of the magneto-mechanical oscillators 1300. Approaching the angle of 55° from lower values, the dynamics of the lattice may already exhibit undesirable dynamic instabilities, while 30° or lower has a significantly reduced filling factor and will thus sacrifice performance per volume. It is proposed that a lattice angle a close to 45° may represent a desirable trade-off between dynamic stability and close packing.

FIG. 17 illustrates another 2-dimensional nested array 1700 of the magneto-mechanical oscillators 1300 of FIG. 13, in accordance with some implementations. The array 1700 is substantially the same as the array 1600 of FIG. 16, except that the direction of magnetization of magnets is the same for each magneto-mechanical oscillator 1300 in a particular line, but opposite from the direction of magnetization of magnets in immediately adjacent lines. Thus, implementations according to any of FIGS. 16-18 describe an array of magneto-mechanical oscillators arranged into a plurality of lines of magneto-mechanical oscillators such that each magneto-mechanical oscillator comprises a magnetic element is disposed at a vertex of a rhombic lattice having a lattice angle of less than or equal to 55°. The term “vertex” may be defined geometrically as an angular point of a polygon, polyhedron, or other figure. The term “rhombic lattice” may also be known as a centered rectangular lattice or an isosceles triangular lattice and may be defined as a group of objects arranged at vertices of a plurality of rhombi, or quadrilaterals having all four sides of equal length. Thus, a “lattice angle” may be the angle formed by two intersecting lines, each passing through a same vertex and each also passing through a respective one of two adjacent vertices in the “rhombic lattice.”

Stable three-dimensional arrays of magneto-mechanical oscillators can be built by layering the proposed two-dimensional lattice. FIG. 18 illustrates a 3-dimensional nested array 1800 of the magneto-mechanical oscillators of FIG. 13, in accordance with some implementations. The array 1800 is shown as nested 2D layers of the array 1700 of FIG. 17 such that every other layer is aligned and adjacent layers are offset such that the magneto-mechanical oscillator 1300 one layer is centered between 4 magneto-mechanical oscillators 1300 in an adjacent layer, such that the distance between the magnetic elements in neighboring planes is maximized. Thus, the plurality of magneto-mechanical oscillators 1300 are arranged in a plurality of rhombic lattices that are arranged in a three-dimensional array. Each rhombic lattice is separated from an adjacent rhombic lattice by a first distance greater than a second distance (e.g., a lattice constant distance) between any two adjacent magneto-mechanical oscillators in any rhombic lattice. However, the present application is not so limited and the array 1800 may alternatively comprise a plurality of layers of the array 1600 of FIG. 16.

If the distance between the layers is sufficiently large, i.e. greater than the lattice constant a, then the desired stability of the two-dimensional lattice will carry over to the three-dimensional assembly of magneto-mechanical oscillators 1300.

For a self-stabilized array of magneto-mechanical oscillators a spring or beam element is not needed to provide a stabilizing torque mechanically, but such an element may still be desirable or needed in order to fix the magnetic elements 1312 to their positions. In this case, the spring or beam element can be made arbitrarily soft against rotational displacements, which may be desirable in order to achieve maximum coupling between two self-stabilized arrays when used for wireless power transfer.

There may exist many other two- and three-dimensional lattices, which comprise magnets arranged in lines such that the array is self-stabilized. The present application is not limited to the specific lattice geometry shown in FIGS. 16-18, but broadly includes all 2D and 3D arrays of magneto-mechanical oscillators 1300 which are self-stabilized by building the lattice from lines of magneto-mechanical oscillators 1300, where the distance between adjacent lines is larger than the distance between the magneto-mechanical oscillators 1300 within a line. For any given such structure the distance between the lines that achieves the desired stability may be determined by computer simulations.

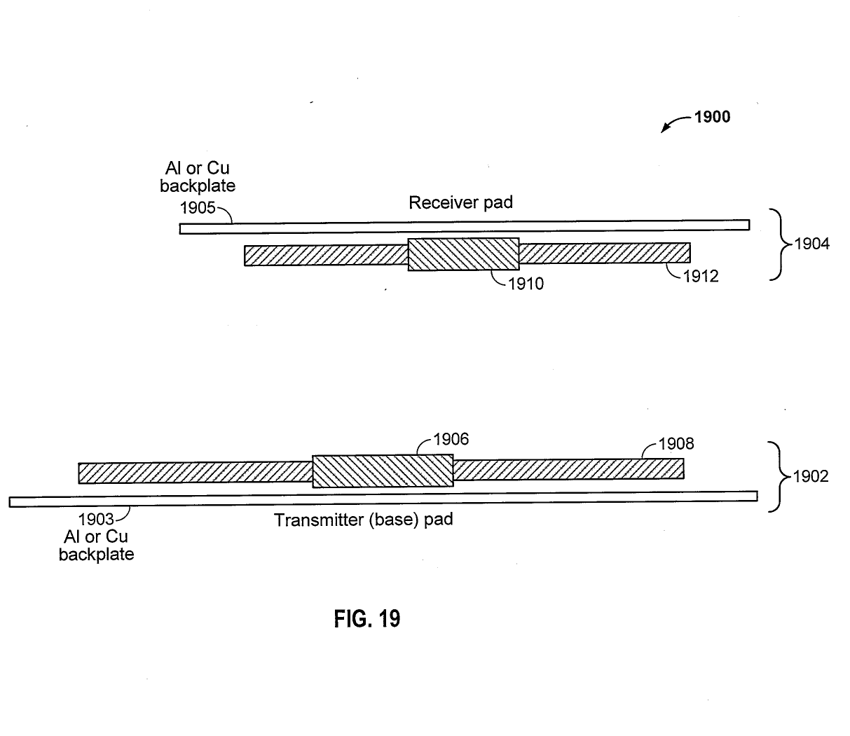

FIG. 19 schematically illustrates an example configuration 1900 of a power transmitter 1902 (e.g., a transmitter base pad coupled to an aluminum or copper back plate 1903) and a power receiver 1904 (e.g., a receiver pad coupled to an aluminum or copper back plate 1905), in accordance with some implementations. For planar low-profile designs for a power transfer pad, the power transmitter 1902 and/or the power receiver 1904 described herein may be used. For example, the power transmitter 1902 can comprise at least one coil 1906 and at least one structure 1908 comprising a plurality of magneto-mechanical oscillators as described herein, and the power receiver 1904 can comprise at least one coil 1910 and at least one structure 1912 comprising a plurality of magneto-mechanical oscillators as described herein. Certain such configurations can lead to solutions that are analogous to a planar “solenoid” coil that uses a flat ferrite core (e.g., analogous to the at least one coil described herein) and a conductive back plate to shape the magnetic field. In certain such configurations, the system generates a substantially horizontal magnetic moment and may be characterized by a relatively strong coupling, even in misalignment conditions. As opposed to the “solenoid” configurations, certain implementations described herein have the potential for higher Q-factors and do not require tuning capacitors (e.g., by using a core that is self-resonant). Losses in certain implementations described herein may be reduced to eddy current losses, but virtually no hysteresis losses and copper losses.

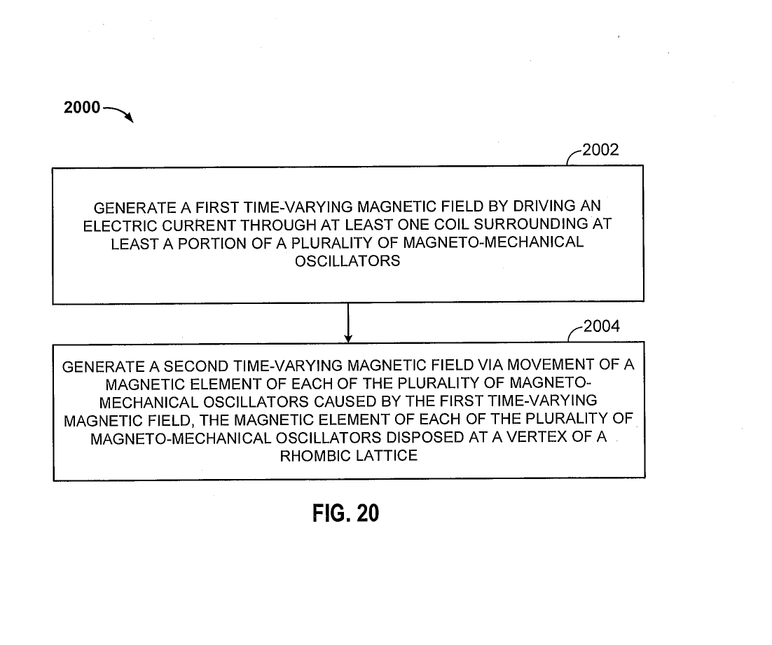

FIG. 20 is a flowchart 2000 of a method for transferring power wirelessly, in accordance with some implementations. Although the flowchart 2000 is described herein with reference to a particular order, in various implementations, blocks herein may be performed in a different order, or omitted, and additional blocks may be added.

The flowchart 2000 may begin with operation block 2002, which includes generating a first time-varying magnetic field by driving an electric current through at least one coil surrounding at least a portion of a plurality of magneto-mechanical oscillators. For example, as previously described in connection with FIG. 9, a first time-varying magnetic field 906 may be generated by driving an electric current through at least one coil 914 surrounding at least a portion of a plurality of magneto-mechanical oscillators 910. In some implementations, the at least one coil 914 may also be known as, or comprise at least a portion of, “means for generating a first time-varying magnetic field.”

The flowchart 2000 may advance to operation block 2004, which includes generating a second time-varying magnetic field via movement of a magnetic element of each of the plurality of magneto-mechanical oscillators caused by the first time-varying magnetic field, the magnetic element of each of the plurality of magneto-mechanical oscillators disposed at a vertex of a rhombic lattice. For example, as previously described in connection with at least FIG. 9, a second time-varying magnetic field 912 may be generated via movement of each of the plurality of magneto-mechanical oscillators 910 (e.g., movement of the magnetic element 1312 as shown in FIG. 13) caused by the first time-varying magnetic field 906. In some implementations, the magneto-mechanical oscillators 1300 shown in FIG. 13 may also be known as, or comprise at least a portion of, “a plurality of means for generating a second time-varying magnetic field.”

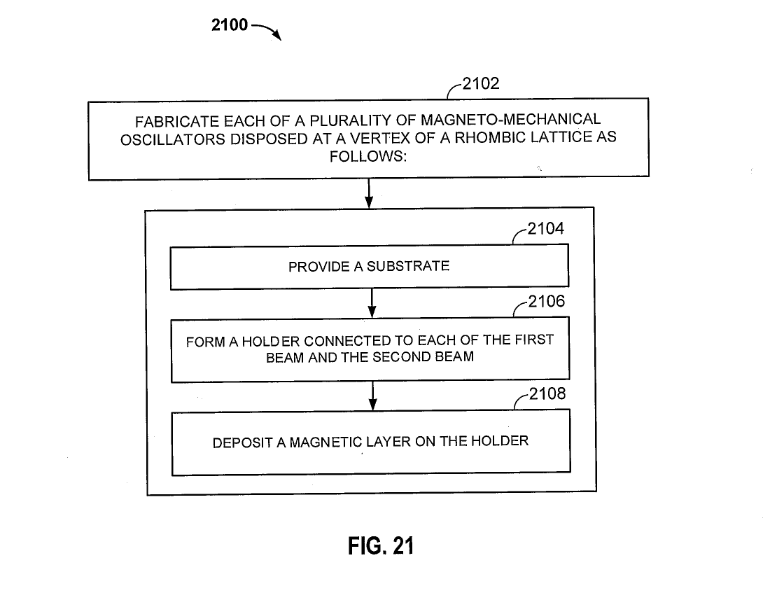

FIG. 21 is a flowchart 2100 of a method for fabricating a plurality of magneto-mechanical oscillators, in accordance with some implementations. The flowchart 2100 may represent a method for fabricating magneto-mechanical oscillators as shown in either of FIGS. 13-15, as well as any 2- or 3-dimensional array of such magneto-mechanical oscillators. Although the flowchart 2100 is described herein with reference to a particular order, in various implementations, blocks herein may be performed in a different order, or omitted, and additional blocks may be added. Unless otherwise stated, any operation including the term “form” or “deposit” may be understood to mean depositing a suitable material utilizing any of physical vapor deposition (PVD), chemical vapor deposition (CVD), electro-deposition, or etching already present materials utilizing micro-structuring methods such as photolithography and etching, although other methods of deposition and etching may also be utilized. Operation blocks 2104-2112 may be carried out for each of a plurality of magneto-mechanical oscillators comprising a magnetic element disposed at a vertex of a rhombic lattice having a lattice angle of less than or equal to 55°, for example, as shown in FIGS. 14-18. In such implementations, each of operations blocks 2104-2112 may be performed in such a way so as to result in the “nested” arrangements as shown in FIGS. 14-18.

The flowchart 2100 may begin with operation block 2102, which includes fabricating each of a plurality of magneto-mechanical oscillators having a magnetic element disposed at a vertex of a rhombic lattice. This operation block may be the aggregate of one or more of the operation blocks 2104-2112 below. In some implementations, a lattice angle of the rhombic lattice may be less than or equal to 55 degrees.

Flowchart 2100 may advance to operation block 2104, which includes providing a substrate. In some implementations, the substrate may be pre-formed. In other implementations, the substrate may be actively grown utilizing any of PVD, CVD, or electro-deposition, for example, although other processes may be utilized. The substrate may be made of any suitable material including but not limited to silicon, silicon carbide, silicon nitride, sapphire (Al₂O₃), or diamond. The flowchart 2100 may then advance to operation block 2106.

Operation block 2106 includes forming a holder over the substrate. In some implementations, the holder may be made of the same or a different material as the substrate. The flowchart 2100 may then advance to operation block 2108.

Operation block 2108 includes depositing a magnetic element on the holder. The magnetic element may comprise a ferromagnetic film or layer having a high remanence and, preferably, high coercivity, e.g., NdFeB, SmCo, or other magnetic materials. They may be deposited utilizing sputtering, pulsed laser deposition, electro-deposition, or any other suitable deposition process. Once a 2-dimensional array or rhombic lattice of magneto-mechanical oscillators is fabricated according to blocks 2104-2108 above, a 3-dimensional array may be formed by repeating blocks 2104-2108 for another 2-dimensional array or rhombic lattice substantially offset in one or more directions from, the previously fabricated 2-dimensional array or rhombic lattice, as previously described in connection with FIG. 18.

In some implementations, the flowchart 2100 may additionally include forming a first base support element and a second base support element on the substrate. The first base support element may be made of the same material as the substrate or a different material, depending on the implementation.

In some implementations, the flowchart 2100 may additionally include forming a first beam connected to the first base support element and a second beam connected to the second base support element. The first beam and the second beam may be made of the same material as the substrate and/or the first base support element, or of a different material, depending on the implementation.

In some implementations, the flowchart 2100 may additionally include forming a fixing element connected to the substrate, wherein the holder is connected to the fixing element such that the magnetic element and the holder are constrained to rotate about a fixed axis.

In some implementations, the flowchart 2100 may additionally include winding at least one coil around at least a portion of the plurality of magneto-mechanical oscillators to form an excitation circuit (not shown). In such implementations, where a 3 dimensional array is desired, the flowchart 2100 may additionally include arranging the plurality of magneto-mechanical oscillators in a plurality of rhombic lattices that are arranged in a three-dimensional array, each rhombic lattice separated from an adjacent rhombic lattice by a distance greater than a distance between any two adjacent magneto-mechanical oscillators in any rhombic lattice.

In certain implementations, the wirelessly transferred power is used for wirelessly charging an electronic device (e.g., wirelessly charging a mobile electronic device). In certain implementations, the wirelessly transferred power is used for wirelessly charging an energy-storage device (e.g., a battery) configured to power an electric device (e.g., an electric vehicle).

The various operations of methods described above may be performed by any suitable means capable of performing the operations, such as various hardware and/or software component(s), circuits, and/or module(s). Generally, any operations illustrated in the figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations of the invention.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer readable media. The processor and the storage medium may reside in an ASIC.

For purposes of summarizing the disclosure, certain aspects, advantages and novel features of the inventions have been described herein. It is to be understood that not necessarily all such advantages may be achieved in accordance with any particular implementation of the invention. Thus, the invention may be embodied or carried out in a manner that achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. An apparatus for transferring power wirelessly, comprising:
a plurality of magneto-mechanical oscillators, each magneto-mechanical oscillator comprising a magnetic element disposed at a vertex of a rhombic lattice, each magneto-mechanical oscillator configured to generate a second time-varying magnetic field via movement of the magnetic element of each of the plurality of magneto-mechanical oscillators caused by a first time-varying magnetic field.

2. The apparatus of claim 1, wherein the rhombic lattice has an angle of less than or equal to 55 degrees.

3. The apparatus of claim 1, wherein each of the plurality of magneto-mechanical oscillators comprises:
a first base support element and a second base support element each disposed on a substrate;
a first beam connected to the first base support element and a second beam connected to the second base support element; and
a holder connected to the first beam and to the second beam, the holder supporting the magnetic element.

4. The apparatus of claim 1, wherein a static magnetic field generated by the plurality of magneto-mechanical oscillators provides a restoring force to the magnetic element.

5. The apparatus of claim 1, wherein each of the plurality of magneto-mechanical oscillators comprises:
a holder supporting the magnetic element; and
a fixing element configured to constrain the magnetic element and the holder to rotate about a fixed axis.

6. The apparatus of claim 1, further comprising an excitation circuit configured to generate the first time-varying magnetic field by driving an electric current through at least one coil surrounding at least a portion of the plurality of magneto-mechanical oscillators.

7. The apparatus of claim 1, wherein the rhombic lattice comprises a plurality of nested rows of magneto-mechanical oscillators such that magneto-mechanical oscillators in a nested row are disposed in spaces between adjacent magneto-mechanical oscillators in an adjacent nested row.

8. The apparatus of claim 1, wherein the plurality of magneto-mechanical oscillators are arranged in a plurality of rhombic lattices that are arranged in a three-dimensional array, each rhombic lattice separated from an adjacent rhombic lattice by a first distance greater than a second distance between any two adjacent magneto-mechanical oscillators in any rhombic lattice.

9. The apparatus of claim 1, wherein each magneto-mechanical oscillator of the plurality of magneto-mechanical oscillators is configured to resonate at a frequency of the first time-varying magnetic field.

10. A method for transferring power wirelessly, comprising:
generating a second time-varying magnetic field via movement of a magnetic element of each of a plurality of magneto-mechanical oscillators caused by a first time-varying magnetic field, the magnetic element of each of the plurality of magneto-mechanical oscillators disposed at a vertex of a rhombic lattice.

11. The method of claim 10, wherein the rhombic lattice has a lattice angle of less than or equal to 55 degrees.

12. The method of claim 10, wherein each of the plurality of magneto-mechanical oscillators comprises:
a first base support element and a second base support element each disposed on a substrate;
a first beam connected to the first base support element and a second beam connected to the second base support element; and
a holder connected to the first beam and to the second beam, the holder supporting the magnetic element.

13. The method of claim 10, wherein a static magnetic field generated by the plurality of magneto-mechanical oscillators provides a restoring force to the magnetic element.

14. The method of claim 10, wherein the rhombic lattice comprises a plurality of nested rows of magneto-mechanical oscillators such that magneto-mechanical oscillators in a nested row are disposed in spaces between adjacent magneto-mechanical oscillators in an adjacent nested row.

15. The method of claim 10, wherein the plurality of magneto-mechanical oscillators are arranged in a plurality of rhombic lattices that are arranged in a three-dimensional array, each rhombic lattice separated from an adjacent rhombic lattice by a first distance greater than a second distance between any two adjacent magneto-mechanical oscillators in any rhombic lattice.

16. A method for fabricating an apparatus for wireless power transmission, the method comprising:
fabricating each of a plurality of magneto-mechanical oscillators disposed at a vertex of a rhombic lattice by:
providing a substrate;
forming a holder over the substrate; and
depositing a magnetic layer on the holder at the vertex of the rhombic lattice.

17. The method of claim 16, wherein the rhombic lattice has a lattice angle of less than or equal to 55 degrees.

18. The method of claim 16, wherein fabricating each of the plurality of magneto-mechanical oscillators further comprises:
forming a first base support element and a second base support element on the substrate; and
forming a first beam connected to the first base support element and a second beam connected to the second base support element, the holder connected to each of the first beam and the second beam.

19. The method of claim 16, wherein fabricating each of the plurality of magneto-mechanical oscillators further comprises forming a fixing element connected to the substrate, the holder connected to the fixing element such that the magnetic layer and the holder are constrained to rotate about a fixed axis.

20. The method of claim 16, wherein the rhombic lattice comprises a plurality of nested rows of magneto-mechanical oscillators such that magneto-mechanical oscillators in a nested row are disposed in spaces between adjacent magneto-mechanical oscillators in an adjacent nested row.

21. The method of claim 16, further comprising arranging the plurality of magneto-mechanical oscillators in a plurality of rhombic lattices that are arranged in a three-dimensional array, each rhombic lattice separated from an adjacent rhombic lattice by a first distance greater than a second distance between any two adjacent magneto-mechanical oscillators in any rhombic lattice.

22. An apparatus for transferring power wirelessly, comprising:
means for generating a first time-varying magnetic field; and
a plurality of means for generating a second time-varying magnetic field via movement of the means for generating the second time-varying magnetic field caused by the first time-varying magnetic field, each means for generating the second time-varying magnetic field disposed at a vertex of a rhombic lattice.

23. The apparatus of claim 22, wherein the rhombic lattice has a lattice angle of less than or equal to 55 degrees.

24. The apparatus of claim 22, wherein each of the plurality of means for generating the second time-varying magnetic field comprises:
a first base support element and a second base support element each disposed on a substrate;
a first beam connected to the first base support element and a second beam connected to the second base support element;
a holder connected to the first beam and to the second beam; and
a magnetic element disposed on the holder.

25. The apparatus of claim 24, wherein a static magnetic field generated by the plurality of means for generating the second time-varying magnetic field provides a restoring force to the magnetic element.
